(19) United States
(12) Patent Application Publication
(10) Pub. No.: US 2012/0197981 A1
(43) Pub. Date: Aug. 2, 2012

(54) Automated Information Update System

(76) Inventor: Jawe Chan, Pleasanton, CA (US)

(21) Appl. No.: 13/363,373

(22) Filed: Jan. 31, 2012

Related U.S. Application Data
(60) Provisional application No. 61/462,369, filed on Feb. 1, 2011.
(60) Provisional application No. 61/475,674, filed on Apr. 15, 2011.
(60) Provisional application No. 61/536,057, filed on Sep. 19, 2011.
(60) Provisional application No. 61/556,178, filed on Nov. 4, 2011.
(60) Provisional application No. 61/556,220, filed on Nov. 5, 2011.
(60) Provisional application No. 61/588,671, filed on Jan. 20, 2012.

(51) Int. Cl. G06F 15/16; G06Q 99/00; H04L 9/32; G06Q 30/02

(52) U.S. Cl. 709/203; 705/14.72; 705/319; 726/5

(57) ABSTRACT

Information relating to a computer embedded object for sale can be found through a specification searching criteria derived from an identification code, configuration, and/or specification of the seller's computer embedded object. The computer embedded object can be a mobile device, an accessory of mobile device, a mobile subscription plan, or a vehicle. The identification code can be used to identify the seller's computer embedded object, configuration, and/or specification. The information may be automatically updated using the configuration of the computer embedded object and can be provided to a group of potential buyers to view and to complete sales transactions.

### CROSS-REFERENCE TO RELATED APPLICATIONS

### Benefit Claim

This application claims the benefit of Provisional Appln. No. 61/462,369, filed Feb. 1, 2011; of Provisional Appln. No. 61/475,674, filed Apr. 15, 2011; of Provisional Appln. No. 61/536,057, filed Sep. 19, 2011; of Provisional Appln. No. 61/556,178, filed Nov. 4, 2011; of Provisional Appln. No. 61/556,220, filed Nov. 5, 2011; and of Provisional Appln. No. 61/588,671, filed Jan. 20, 2012, the entire contents of all of which is hereby incorporated by reference as if fully set forth herein, under 35 U.S.C. §119(e).

### FIELD OF THE INVENTION

The present invention relates to uploading reference information using upload criteria derived from an identification code or a specification of a consumer computer system.

### BACKGROUND

The Internet is a revolutionary technology for accessing information. A user can access information or sell their merchandise around the world with a simple click of a mouse button. In light of society's popular acceptance of the Internet, the amount of information accessible via the Internet has been growing exponentially. For example, a consumer can sell a large amount of merchandise using an Internet storefront. In many cases, the seller only needs the update the merchandise information in the online shopping database for the storefront. The information can be further used for advertising purposes.

From time to time, a seller may update the merchandise that he has for sale, e.g., a mobile computing device or vehicle, on the Internet. In many cases the seller must enter such the merchandise information manually. Normally, the information for the mobile device or vehicle cannot be entered automatically. It has to be manually entered onto the online retail site, e.g., Amazon, eBay, or any other online retail store.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of a server that stores and retrieves object data, according to possible embodiments of the present invention;

FIG. 2 illustrates an example of end-user computers communicating with a server, according to a possible embodiment of the present invention;

FIG. 3 illustrates an example block diagram of a computer system, according to a possible embodiment of the present invention;

FIG. 4 illustrates an example process flow, according to a possible embodiment of the present invention;

FIG. 5 illustrates an example process flow, according to a possible embodiment of the present invention;

FIG. 6 illustrates an example process flow, according to a possible embodiment of the present invention;

FIG. 7 illustrates an example process flow, according to a possible embodiment of the present invention;

FIG. 8 illustrates an example user interface for a seller, according to a possible embodiment of the present invention;

FIG. 9 illustrates an example user interface for a buyer, according to a possible embodiment of the present invention;

FIG. 10 illustrates an example user interface for a seller to manage devices for sale that are connected to a network, according to a possible embodiment of the present invention;

FIG. 11 illustrates an example data structure and content that may be submitted to a search engine, according to a possible embodiment of the present invention;

FIG. 12 illustrates an example data structure and content that may be submitted to an online retailer store, according to a possible embodiment of the present invention;

FIG. 13 illustrates an example data structure and content that may be submitted to a social network, according to a possible embodiment of the present invention;

FIG. 14a illustrates an example specification information comparison, according to a possible embodiment of the present invention;

FIG. 14b illustrates an example specification information comparison, according to a possible embodiment of the present invention;

FIG. 15 illustrates a list of promotional parameters for various objects that maybe sold, according to a possible embodiment of the present invention;

FIG. 16 illustrates an example list of promotional parameters used to create a web page to promote objects, according to a possible embodiment of the present invention;

FIG. 17 illustrates an example seller user input interface for a seller to add additional information that describes an object for sale, according to a possible embodiment of the present invention;

FIG. 18 illustrates an example seller user interface for recycling an object, according to a possible embodiment of the present invention;

FIG. 19 illustrates an example web page template before and after a user object is identified, according to a possible embodiment of the present invention;

FIG. 20 illustrates an example logic structure, according to a possible embodiment of the present invention;

FIG. 21 illustrates an example logic structure, according to a possible embodiment of the present invention;

FIG. 22 illustrates a list of object model or specification search results from a search engine, according to a possible embodiment of the present invention;

FIG. 23 illustrates an example buyer's user interface, according to a possible embodiment of the present invention;

FIG. 24 illustrates an example seller's user interface, according to a possible embodiment of the present invention;

FIG. 25 illustrates an example seller's user interface, according to a possible embodiment of the present invention;

FIG. 26 illustrates an example process flow, according to a possible embodiment of the present invention;

FIG. 27 illustrates an example social networking user interface, according to a possible embodiment of the present invention;

FIG. 28 illustrates an example social networking user interface, according to a possible embodiment of the present invention;

FIG. 29 illustrates an example social networking user interface, according to a possible embodiment of the present invention;

FIG. 30 illustrates an example process flow, according to a possible embodiment of the present invention; and

FIG. 31 illustrates an example hardware platform on which a computer or a computing device as described herein may be implemented, according a possible embodiment of the present invention.

FIG. 32 illustrates an example access information flow, according to a possible embodiment of the present invention;

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Example embodiments are described herein according to the following outline:

1. GENERAL OVERVIEW

2. EXAMPLE SYSTEM ARCHITECTURE

3. EXAMPLE EMBODIMENTS AND APPLICATIONS

4. HARDWARE OVERVIEW

5. EQUIVALENTS, EXTENSIONS, ALTERNATIVES AND MISCELLANEOUS

### 1. General Overview

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format, and should be understood as merely a conceptual prelude to a more detailed description of example possible embodiments that follows below.

In a possible embodiment, a system and method of automatically matching sellers of computer embedded objects with potential buyers through a communications network, the server computer searches a database for reference information that matches a search criteria derived from an identification code or the configuration of a computer embedded object. The reference information may be related to one of the following: selling price, selling configuration, a marketing package (that includes, but is not limited to, the presentation or web page generation of the online store front, etc.), recommended advertisements, promotions or cross promotions, online email marketing campaign, Search Engine Optimization (SEO) Campaign, automatic online retailer store submission, a list of online retailer stores, Internet marketing campaign information, Pay-Per-Click (PPC), Internet advertising banner, link or banner exchange, advertising keyword, advertising cost, method of payment, fund distribution, shipping material, shipping logistics, invoice template, comments or feedback template, charity donation, list and/or monitor of sale activities, how to reset the object to the manufacturer default setup, uploading and/or saving personal information to a safe location, the specification of the computer embedded object, etc.

If the computer embedded object is a vehicle, the uploaded information from a computer embedded object to the server computer may include: a Vehicle Identification Number (VIN), vehicle mileage, maintenance history, make, model, etc.

If the computer embedded object is a mobile device, the uploaded information from the mobile device to the server computer may include: model, manufacturer, processor type, display type, battery model, and log file, etc. Log file(s) may be generated by the computer embedded object to include, for example, usage of the computer embedded object, maintenance history of the computer embedded object, etc. The log file may be generated by a computer program or by user manual input. For example, a program, installed in a smart phone, may be able to keep track of the user's calls, text messages, data usage, etc. The usage information may be saved in a log file(s). A log file of a mobile phone may contain usage statistics of the mobile phone, maintenance history of the mobile phone, or configuration history of the mobile phone, etc.

If the computer embedded object is a TV with an Internet connection, for example, the uploaded information from the TV to the server may include: model, manufacturer, resolution, screen size, etc.

The uploaded information from a computer embedded object to the server computer may include one of the following: identification or configuration of an object embedded in the computer.

The server computer may search a local or remote database for the reference information using search criteria for the device from the uploaded information.

The uploaded information may be a mobile device's identification code used to identify the mobile device and its configuration, e.g.: a hardware description, such as: microprocessor specification, memory size/type, display screen type/resolution, whether the display screen is monochrome or color, color bit depth, keyboard specification, communication connection number/type, etc., or a software description of software residing in the mobile device, e.g.: operating system, applications native/added, etc. The identification code can be selected from at least one of: a string of codes, Internet Protocol (IP) address, Media Access Control (MAC) address, host name, International Mobile Subscriber Identity (IMSI), Temporary Mobile Subscriber Identity (TMSI), International Mobile Equipment Identity (IMEI), Type Allocation Code (TAC), Mobile Equipment Identifier (MEDI), a string of ASCII characters, a serial number, FCC ID, model number, etc. The reference information may be the object's advertisement information displayed to the online retailer site.

In a possible embodiment, a software or firmware component of the computer embedded object might search a network-accessible database for the reference information directly by using its identification code or the configuration of the computer embedded object as the search criteria (the database containing the reference information may be directly accessible to the computer embedded object). The search results associated with the computer embedded object may be uploaded to a server computer. The server computer may publish the merchandise or service information derived from the uploaded search result information to an online store. A potential buyer of the computer embedded object may manually or automatically search the uploaded information using a predetermined purchase criteria. The contact or the online status or the availability status of the buyer or seller may be available or exchanged between the buyer and seller.

In a possible embodiment, a mobile device manufacturer use an identification code (e.g., IMEI) to identify the model of the cellular phone. IMEI is made up of a Type Allocation Code (TAC) and a serial number called the SNR. The TAC identifies the phone manufacturer and model. There can be several different TACs for the same model phone. Prior to 2004, the TAC consisted of the first six digits of the IMEI, since then, the TAC has been allocated the first eight digits of the IMEI. The TAC is followed by a six digit SNR and a one bit checksum. This makes the IMEI a 15-digit number in recent phones and a 13-digit number in older (pre-2004) phones. A lookup table, a string of codes vs. mobile device model, or a mobile device specification, is available per mobile device manufacturer. With this lookup table, the mobile application software can send the string of codes to a server to retrieve the mobile device's specification. A featured mobile device (selected using promotional information) with similar or better specifications than the mobile device can be selected by a server to be presented to the user using information in the mobile device specification.

In a possible embodiment, a mobile device manufacturer can use a unique string of codes, such as a MAC address, to identify a mobile device. The unique string of codes is not limited to IMEI or MAC addresses.

In a possible embodiment, a reward system can be implemented. After a seller and buyer's information is matched by the system and the buyer has purchased the merchandise, the service provider that maintains the database or server can be paid a percentage of the purchasing price or paid a fixed amount. The seller may receive the remainder of the purchase proceeds from, for example, a pay service such as PayPal, a credit card company, etc.

In a possible embodiment, a pay-per-click method or system can also be further implemented. The service provider may get paid a fee when either a buyer or a seller accesses items from a list that is provided to them. In many cases, commercial enterprises can profit through this infrastructure by providing services that attach a small, incremental monetary value to a particular transaction.

### Example System Architecture

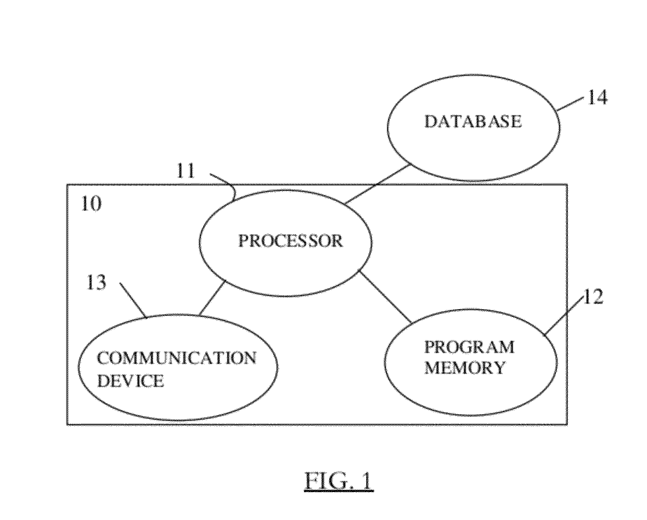

FIG. 1 illustrates a block diagram of a server 10 that stores and retrieves object data. Server 10 can include a processor 11, program memory 12, a communication device 13, and a database for objects 14. The communication device 13 may be a modem or a high-speed leased line router. In a possible embodiment, server 10 is an information server and processor 11 is in data communication with various end-user computer systems via the Internet. However, in other possible embodiments, the server 10 could be implemented with a processor 11 having multiple modems to receive calls directly from end-user computer systems and establishing data communication via the modems and public phone lines, e.g., POTS. The database 14 may include the promotion information for objects that includes, but is not limited to: e-coupons, coupons or product sales events, price of an object, an identification of an object, etc.

An example of a server 10 is a system operating in accordance with the Sun MicroSystems Solaris operating system, Linux, Microsoft Windows Server, etc. Processor 11 may be any general-purpose processor having a CPU, RAM, ROM, and I/O circuitry.

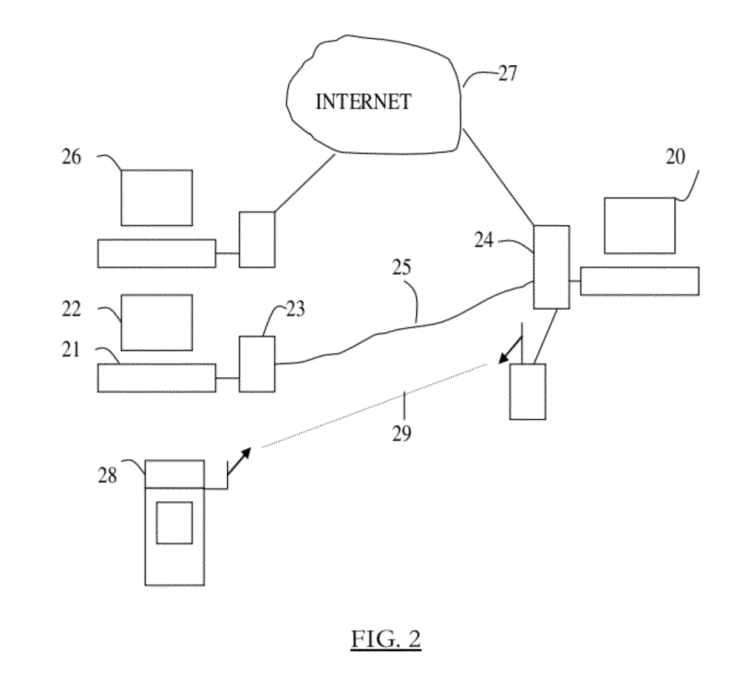

Referring to FIG. 2, end-user or seller computers 21, 26, 28, communicate with server 10 in a variety of ways. In a possible embodiment, end-user or seller computer system 21 connects to server 10 via modem 23 and modem 24 through phone line 25. In a possible embodiment, end-user or seller computer 21 can be communicatively connected to a display device 22. In another possible embodiment, display device 22 may be incorporated within end-user or seller computer 21. In a further possible embodiment end-user or seller computer system 26 is also connected to server 10 through Internet 27. End-user or seller computer system 28 connects to server 10 through radio frequency link 29.

A possible embodiment uses server 10 to access database 14. Database 14 may include reference information related to a computer embedded object and/or may include a computer embedded object merchandise database and/or a merchandise promotional database (comprising information such as, promotional information (e.g., e-coupons, coupons, product sales events, etc.), business directory information, etc.).

The reference information in database 14 may be related to one or more of the following: selling price, configuration, marketing package (that includes, but is not limited to: the presentation or web page generation of the online store front, etc.), recommended advertisements, promotion or cross promotions, online email marketing campaigns, Search Engine Optimization (SEO) Campaign, automatic online retailer store submission, a list of online retailer stores, Internet marketing campaign information, Pay-Per-Click (PPC), Internet advertising banners, link or banner exchange, advertising keywords, advertising cost, method of payment, fund distribution, shipping material, shipping logistics, invoice template, comments or feedback templates, charity donation, list and/or monitor of sale activities, how to reset the object to the manufacturer default setup, uploading and/or saving personal information to a safe location, the specification of the computer embedded object, etc. Once the seller uploads his merchandise information, that is derived from the reference information, to the server, the database 14 can be searched using a buyer's search criteria. Server can send, to both the buyer's and seller's computer, a “match notification” that indicates that a buyer's buying criteria and seller's selling criteria has been matched. A list of potential buyers can be displayed on the seller's computer display and a list of sellers of the merchandise of interest can be displayed on the buyer's computer display. Database 14 can store both lists.

Database 14 can be a centralized database system that stores the data about object promotion information. However, in other possible embodiments, database 14 may be implemented as a distributed database system that stores the information in several computer systems and may be located in different geographical areas. Each of the distributed databases may store data about object information in a local area, such as a particular state, city, or country.

In a possible embodiment, database 14 may be implemented as a relational database, XML database, etc., using MySQL, PostgreSQL, Microsoft Access, SQL Server, FileMaker, Oracle, RDBMS, dBASE, Clipper, FoxPro, etc. Queries formed by server 10 are in a format corresponding to the database method being used by database 14. In other possible embodiments, database 14 may be implemented as a lookup table or a flat file. Computer IDs (identification code of the seller's computer) and/or seller's computer configuration can be searched for in database 14 in order to retrieve the reference information that an end-user or seller is looking for.

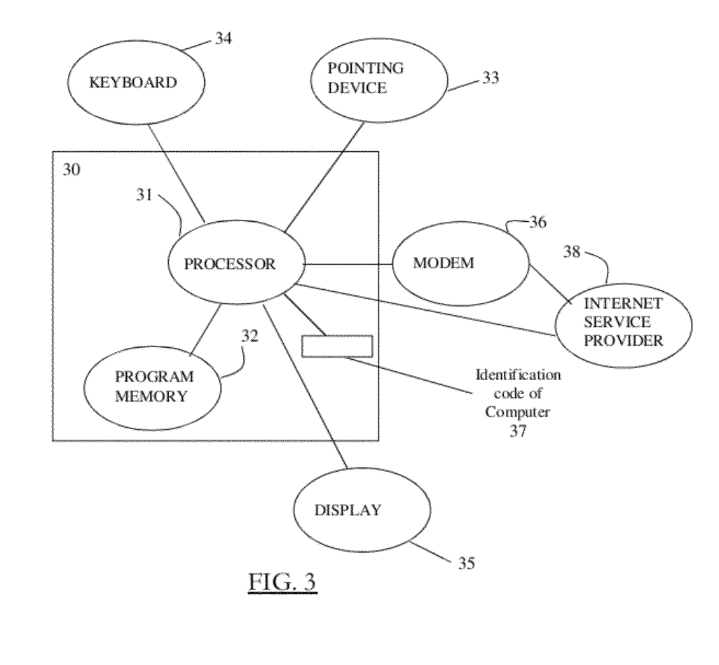

Referring to FIG. 3, a block diagram of an example end-user or seller computer system is shown. Computer system 30 comprises a processor 31, program memory 32, a mouse 33 and keyboard 34 for user or seller input, a display 35, a modem 36, and identification code of end-user or seller computer system 37. A connection from computer system 30 to an Internet Service Provider (ISP) 38 is also shown. The connection may be via broadband, wired, wireless, satellite, POTS, DSL, ADSL, etc. In the environment of FIG. 2, system 30 is an end-user or seller computer system, and processor 31 is in data communication with an Internet Service Provider 38. The Internet Service Provider 38 transmits the data to the server 10 via the Internet. In other possible embodiments, the system could be implemented with a processor 31 having a modem 36 calling directly to the server 10 and establishing the data communication link via the modem 36. Alternatively, the system could be implemented such that the end-user or seller computer system 30 and server 10 are connected via a local network.

In a possible embodiment, the network includes a data network based on an Internet Protocol (IP). In another possible embodiment, the network includes a wired Local Area Network (LAN) such as an Ethernet LAN. In one embodiment, the network includes a Wireless Local Area Network (WLAN). In yet another possible embodiment, the network includes a Wide Area Network (WAN). In another possible embodiment, the network includes a public data network, such as a WiFi hotspot network, or a cellular data network such as General Packet Radio Service (GPRS) network. In a possible embodiment, the network includes a private data network such as a home network, a corporate network, a regional corporate network or a corporate Virtual Private Network (VPN). In another possible embodiment, the network includes a service provider network.

The ID code of end-user or seller computer 37 is resident in the hardware of end-user or seller computer 30. End-user or seller computer system 30 can send the end-user or seller computer ID 37 to server 10. Alternatively, the end-user or seller of end-user or seller computer system 30 can input the ID code from another input device, for example from a keyboard 34, if the user knows the computer ID or would like to search for object information using another computer ID.

An example of a suitable end-user or seller computer system 30 is one operating in accordance with the Microsoft operating system, Apple Mac OS, Linux, etc. Processor 31 may be any general-purpose processor having a CPU, RAM, ROM, and I/O circuitry. Other input devices instead of, or in addition to, mouse 33 and keyboard 34 could be used, such as trackballs, touch pads, graphic tablet, or joysticks. The processor 31 is programmed to execute a process to help the user and accept and process the user's input.

A possible embodiment includes a system and method that automatically matches sellers of computer embedded objects with potential buyers. A server can search a database 14 for reference information that matches a search criteria derived from an identification code of a seller's computer embedded object or from the configuration information of a seller's computer embedded object. The reference information in database 14 may be related to one or more of the following: selling price, configuration, marketing package (that includes, but is not limited to: the presentation or web page generation of the online store front, etc.), recommend advertisement, promotion or cross promotion, online email marketing campaign, Search Engine Optimization (SEO) Campaign, automatic online retailer store submission, a list of online retailer stores, Internet marketing campaign information, Pay-Per-Click (PPC), Internet advertising banner, link or banner exchange, advertising keywords, advertising cost, method of payment, fund distribution, shipping material, shipping logistics, invoice template, comments or feedback template, charity donation, list and/or monitor of sale activities, how to reset the object to the manufacturer default setup, uploading and/or saving personal information to a safe location, the specification of the computer embedded object, etc. Once the seller uploads his merchandise information, that is derived from the reference information, to the server, the database 14 can be searched using a buyer's search criteria. Server can send, to both the buyer's and seller's computer, a “match notification” that indicates that a buyer's buying criteria and seller's selling criteria has been matched. A list of potential buyers can be displayed on the seller's computer display and a list of sellers of the merchandise of interest can be displayed on the buyer's computer display. Database 14 can store both lists.

In a possible embodiment, database 14 could also be arranged in an object-oriented manner for attribute searching.

In a possible embodiment, a reference database may be linked or joined to the database 14. The reference database may also be integrated with the database 14 to be part of the database for an embodiment. This reference database may be such as Google's Adwords database, comprising information associated with computer embedded objects, is accessible to sellers of computer embedded objects. A list of keywords for promoting the sale of the computer embedded objects can be displayed to sellers. Server 10 analyzes data associated with keywords, such as Google's Adwords, that are available for promoting the sale of a particular type of computer embedded object. The keywords identify one or more specific attributes of the computer embedded object for sale and associate identified configuration attributes with the computer embedded object in order to facilitate parameters that can be searched by a buyer. Database 14 can be arranged in a manner that allows a correlation to be created between a seller's computer embedded object configuration and the associated specification attributes for the computer embedded object. Any identified parameters within the reference information, such as keywords, e.g., Google's Adwords or meta tags for search engines, of the computer embedded object can be displayed based on a configuration attribute of the computer embedded object.

In a possible embodiment, server 10 may employ a keyword generation function that automatically processes the identification code or configuration of a computer embedded object to generate keywords, e.g., Google Adwords keywords. The computer embedded object may be a mobile phone, vehicle, etc.

In a possible embodiment, server 10 may employ a meta tag generation function that automatically reads the identification code of configuration of a computer embedded object to generate meta tags for web pages. A group of meta tag listings may be generated. In one possible embodiment, each of the meta tags listings may be associated with an individual computer embedded object. These meta tags may be used to increase the web page search ranking in a search engine. In one other possible embodiment, a group of the meta tags listings may be generated, where each of the meta tags lists may be targeted to a specific search engine for a better search ranking under a specific keyword. This group of the meta tags listings may be associated with a single computer embedded object. For example, server 10 may generate three mega tag listings based on a single xyz brand mobile phone. The first meta tag listing may consist of, for example, a description, keywords, and robots. This first meta tag may be for a better “first search engine” ranking under a keyword, e.g., “smartphone”. The second meta tag listing may consist of, for example, a description, keywords, robots, language, and author. This second meta tag may be for a better “second search engine” ranking under a keyword, e.g., “teléfono inteligente” (in other language, such as Spanish). The third meta tag listing may consist of, for example, a description, keywords, robots, and revisit. This third meta tag listing may be for a better search engine ranking under a keyword, e.g., “mobile phone”. In one other possible embodiment, a group of the meta tags listings may be generated for multiple computer embedded objects, where each of the meta tags lists may be targeted to a specific search engine for a better search ranking under a specific keyword.

In a possible embodiment, server 10 may employ a marketing function that processes the identification code or configuration of a computer embedded object and generates media to promote sales of the computer embedded object. The media may be one or more of: keywords for Google Adwords, meta tags for web pages to improve the search ranking from an Internet search engine (e.g., Google, Yahoo, Bing, etc.), keywords to increase Internet traffic, audio or video to increase Internet traffic, etc. Keywords may be generated as one or more of the following types: explicit keywords (e.g., that directly describe the product or service), problem based type of keywords (e.g., that describe the conditions or problems the computer embedded object can solve if the object is purchased), product name or part numbers (e.g., that describe the product name or part number of the computer embedded object), a string of ASCII codes associated with the computer embedded object, etc. A group of keyword listings may be generated, where each keyword listing is associated to an individual computer embedded object.

In a possible embodiment, server 10 may employ a marketing function that processes the identification code or configuration of a computer embedded object and generates a notification to a potential seller. The potential seller may edit, update or approve the presentation, advertisement or web page suggested by the server 10. Once the advertisement or the presentation of the online store front is updated, one or multiple notification(s), initiated by the seller or at the request of potential buyer(s) through a potential seller pre-set condition, may be sent to the potential buyer(s) in order to increase the Internet traffic of web content. The marketing function may include one or more of: a text message or notification, email notification, audio message or notification, video message or notification, etc. A group of notification listings may be generated, where each notification listing is associated with an individual computer embedded object.

In a possible embodiment, server 10 may employ a marketing function that processes the identification code or configuration of a computer embedded object and generates web content or a URL. The marketing function may include the generation or optimization of one or more of: a landing page URL or content, a keyword page URL or content, a payment page URL or content, advertisement content or URL, etc. A group of the web content or URL listings may be generated, where each web content or URL listing is associated with an individual computer embedded object.

In a possible embodiment, server 10 may include a system that generates keyword statistical information associated with a computer embedded object. A seller of the computer embedded object can select one or more keywords, according to the keyword statistical information, to promote the sales of his computer embedded object. The seller can apply keywords to a group of computer embedded objects.

In a possible embodiment, server 10 may employ a system that allows a seller to select a list of conditions where the seller's advertisement may be triggered on or off, after the server 10 accesses the identification code or configuration of a computer embedded object. The conditions may be one or more of:
Trigger the seller's advertisement to appear (e.g., in a listing, etc.) when the searcher uses a query that is related to the computer embedded object's keywords, e.g., queries containing terms with characteristics such as misspellings, plurals, similar words, etc. This generates broad matches.
Trigger the seller's advertisement to appear (e.g., in a listing, etc.) when phrase match with keywords occurs, e.g., words match within a quotation, etc.
Trigger the seller's advertisement to appear (e.g., in a listing, etc.) when an exact match occurs, e.g., words or query in a search text entry is identical to a keyword in the seller's ad group for his ad to be displayed, etc.
Trigger the seller's advertisement to no longer appear (e.g., in a listing, etc.) when negative key words match, e.g., stop advertisement from being displayed if a negative keyword is matched in a query or search text entry.

In a possible embodiment, server 10 may employ a marketing function that processes the identification code or configuration of a computer embedded object and generates an advertisement content or URL. The marketing function may include the generation or optimization of one or more of: generating unique selling proposition advertisements, generating distinguishing features and benefits advertisements, generating advertisements with headlines, generating advertisements with description lines, generating advertisements that include prices and/or discounts, generating advertisements focused on testimonials, generating advertisements that convey information, generating advertisement templates for seller to select among, etc.

In a possible embodiment, the reference information, derived from the identification code or configuration of a seller's computer embedded object that is available for purchase, is published by the seller via server 10 and can be displayed to a buyer. Server 10 analyzes data associated with computer embedded object to be sold that are available for promoting commercial transaction in order to identify one or more specification attributes of the items and associates the identified configuration attributes with the items in order to facilitate parameters to reach to a buyer. Database 14 can be arranged in a manner that allows a search to be made between a seller's computer embedded object configuration and the associated specification attributes for the computer embedded object to be sold. Any identified parameters, within the reference information of the computer embedded object can be displayed based on a configuration attribute of the item.

In a possible embodiment, a computer ID includes a string of codes. A computer ID could also, or alternatively, include any of: an Internet Protocol (IP) address, a Media Access Control (MAC) address, a host name, an International Mobile Subscriber Identity (IMSI), a Temporary Mobile Subscriber Identity (TMSI), an International Mobile Equipment Identity (IMEI), or a Mobile Equipment Identifier (MEID), a Type Allocation Code (TAC), a string of ASCII characters, a serial number, an FCC ID, a model number, etc.

In a possible embodiment, an object configuration includes, but is not limited to, one or more of the following informational items: operating system name, processor model, processor speed, memory size, memory type, object dimensions, object weight, object color, object style, object type, subscription plan, network connection speed, network connection type, display technology, display size, display resolution, software revision, coverage availability, type of battery, camera resolution quality, ability to be customized, type of keyboard, GPS availability, etc.

The following is an example of an object configuration, where the object is a mobile device:

a. Type of Phone: flip phone, back flip

b. Operating System: Any Operating System for Mobile Phone 2.1

c. Processor: XYZ Brand 1 GHz mobile processor

d. Internal Memory: ROM 1 GB; RAM 576 MB

e. Compatibility: WiFi: 802.11b/g*GPS/AGPS

f. Email: One Exchange, up to 7 POP/IMAP

g. Dimensions: 123×68×10 mm

h. Weight: 157 g (with battery)

i. Display: 4.3-inch HD touch-sensitive screen with 480×800 WVGA resolution

j. Technology: GSM: 850/900/1800/1900 MHz WCDMA/HSPA: 1700 MHz (AWS)/2100 MHz.

In this example, the type of phone can equipped with, but is not limited to, any of: flip phone, back flip, candy bar, smart phone, sliding keyboard, soft keyboard, etc. The operating system can include, but is not limited to, any of: Any Operating System for Mobile Phone 2.1, IOS 4, Windows CE, Windows Phone, Android, etc.

In a possible embodiment, server 10 may send a portion of the database information in database 14 to an end-user or seller's computer 21, 26, 28. The end-user or seller's computer may have a local database manager that has the ability to search or access the portion of the database that it receives from the server 10. For example, server 10 may select the portion of the database information in database 14 using information such as the computer ID of the seller's computer embedded object. The server 10 selects a portion of the information in database 14 that applies to the computer ID, e.g., the computer configuration or specification, any searchable items for commercial transactions, advertisements, any other searchable information, etc. The server 10 sends the selected portion of the database to the seller's computer. The seller's computer can then perform information displays and searches locally in response to the seller's commands and queries.

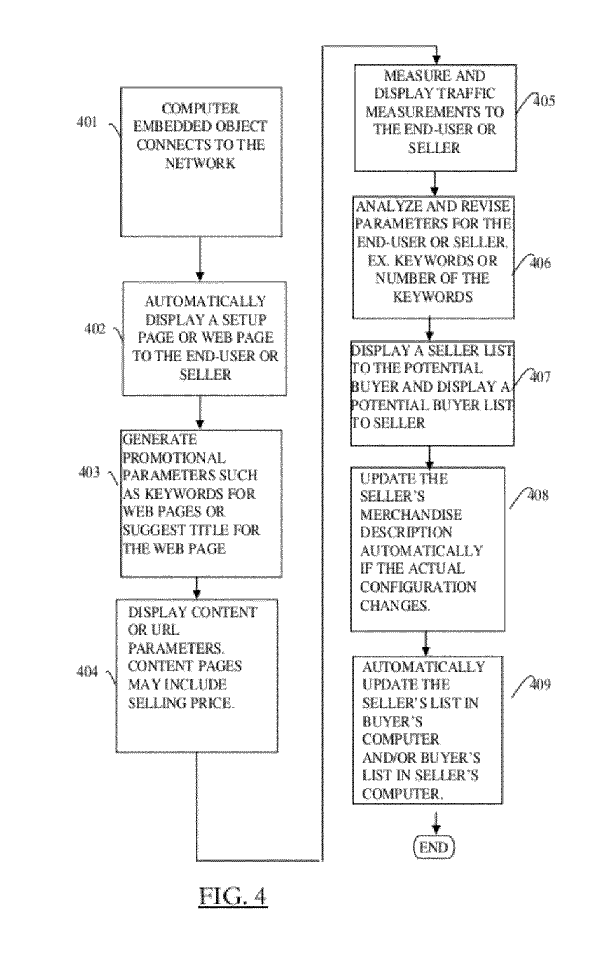

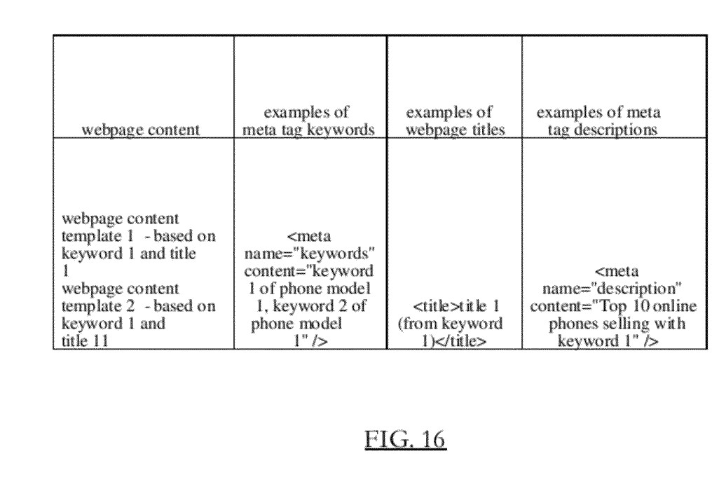

FIGS. 4, 5, 6, and 7, illustrate process flows for possible embodiments. In step 401, the computer embedded object is connected to the network. In step 402, a setup page or Web page may be automatically displayed by the server after the seller logs onto the website. The seller can enter the physical condition of the computer embedded object (described in FIG. 17, below). The ID of the computer embedded object may be obtained automatically by the server or manually input in the setup page by the seller. The setup page may provide one of the following parameters: content and/or URL parameters (e.g., content template and/or URL address related to the computer embedded object comprising any of: landing page content or URL, web content page or URL, keyword page or URL, etc.), promotional parameters (e.g., keywords for meta tags, keywords for Google Adwords, email address for email campaign, news feed for Facebook, etc.), update parameters (e.g., who can update what), etc. The setup page may display the where and what type of sites the information of the computer embedded object can be uploaded to. Sites may also be characterized as an online media which includes, but are not limited to: advertisement site (e.g., Google Adwards, etc.), online retailer site (e.g., eBay, Amazon, etc.), notification site (e.g., email campaign site, etc.), social networking site (e.g., Facebook, etc.), web pages (e.g., the web pages of a website, etc.). Sites may be associated with services and at least one server that provide the services and functionality of the site web pages. In a possible embodiment, when a user interfaces with a site, the user's computer is communicating to the site's at least one server.

In step 403, the server can generate promotional parameters based on the ID of the computer embedded object. Promotional parameters are parameters used to get more end-user or buyers to visit. Promotional parameters may be, but are not limit to, any of: Adwords keywords for Google Adwords, meta tag keyword for web pages (e.g., to be indexed or searched by search engines, etc.), parameters for each of the online retailer sites (e.g., parameters to get more exposure inside the website (the seller may be paying higher fees for different parameters), etc.), parameters for social networking sites (e.g., parameters to be included in all the news feeds of Facebook, etc.), parameters for notification (e.g., a group of email addresses for notification emails to be sent to, etc.), etc. In a possible embodiment, the promotional parameters may be retrieved from a reference database that may be linked or integrated with database 14 or a database that is located in the local computer embedded object and linked or integrated with database 14, and may include the keywords for any of: meta tag, web page title, web page content, etc.

In a possible embodiment, the computer embedded object may be equipped with a memory device that can store the reference information in a manner as it is stored in database 14 for a software application program running on a local computer embedded object to retrieve the promotional parameters information based on the ID of the seller's computer embedded object. The database stored in the local memory of the computer embedded object may be referred to as “local reference information”. The “local reference information” may include limited reference information related to the model or name brand of the computer embedded object. In a possible embodiment, the “reference information” stores all the possible reference information for all the name brands, models, and different types of computer embedded objects (e.g., mobile phones, TVs, vehicles, gaming stations, etc.).

In step 404, the content material of the web page that is associated with a mobile phone's model or configuration may include the selling price of the mobile phone under various physical conditions of the mobile phone. In order for various search engines to get a better search result ranking using keywords, the total number of the keywords in a web page and/or the location (or condition—in the first paragraph or in the bottom of the web page or in the address, etc.) of the keywords in the web page may be monitored and adjusted by the mobile application software or the program running on the server. Content or URL parameters may be used to generate content or URLs of web pages or ads in various online media. For example, if parameters are generated for an Adwords advertisement, any of the following may be generated:
unique selling propositions advertisement,
distinguishing features and benefits advertisement,
advertisements with headline(s),
advertisement with description lines,
advertisement that includes prices or discounts,
advertisement focused on testimonials,
advertisement that conveys information,
advertisement templates (text or video or audio or picture) for seller to choose from.

In step 405, one of the possible ways to track and/or promote Internet traffic is the banner link exchange program that is associated to the ID of the seller's mobile phone. The banner, associated with the ID or model number of the mobile phone, can be generated by the server for a seller to place it in a web page. The link exchange banners may be stored and sorted in database 14, by mobile phone model or ID of the mobile phone. Other possible ways to track and/or promote Internet traffic may include: Webtrend, Google Analytics, etc. In step 406, the Internet traffic for the landing page where the mobile phone sale information is located, may be improved by fine tuning the: number of the keywords in the meta tag (for the web page), number of keywords in the web page, location of the keyword, amount of money (or percentage of the selling price) paid to the operator or its affiliate of the marketing/sales campaign (such as the banner exchange campaign).

In the step 407, after the seller enters the merchandise information into the system, the system may display a list of sellers to any buyers related to the merchandise of interest and/or display a list of buyers to sellers related to the merchandise of interest. Alternatively, the server may send a list of sellers to the computing devices of any buyers related to the merchandise of interest and/or send a list of buyers to the computing devices of sellers related to the merchandise of interest.

In step 408, as an example, if the seller upgrades the memory size of the computer embedded object, the application software may update the computer embedded object's configuration in database 14. The potential buyer may be able to review the updated configuration of the merchandise. The selling price may also be updated accordingly with approval from the seller. This may be an automatic update that may be performed in any of: a configuration change flag (e.g., set or reset the flag which can trigger the application software that runs on the computer embedded object to compare the configuration between the current configuration and the configuration listed in the web pages for the potential buyer to review), a straight database update (e.g., an update to database 14). The application software that runs on the computer embedded object may be constantly polling the I/O of the computer embedded object to get updated configuration information of the computer embedded object. Alternatively, an interrupt may be sent to the application software from an I/O driver of the computer embedded object signaling an update to the configuration of the computer embedded object. With the new configuration, a new suggested price may be sent to the seller for approval.

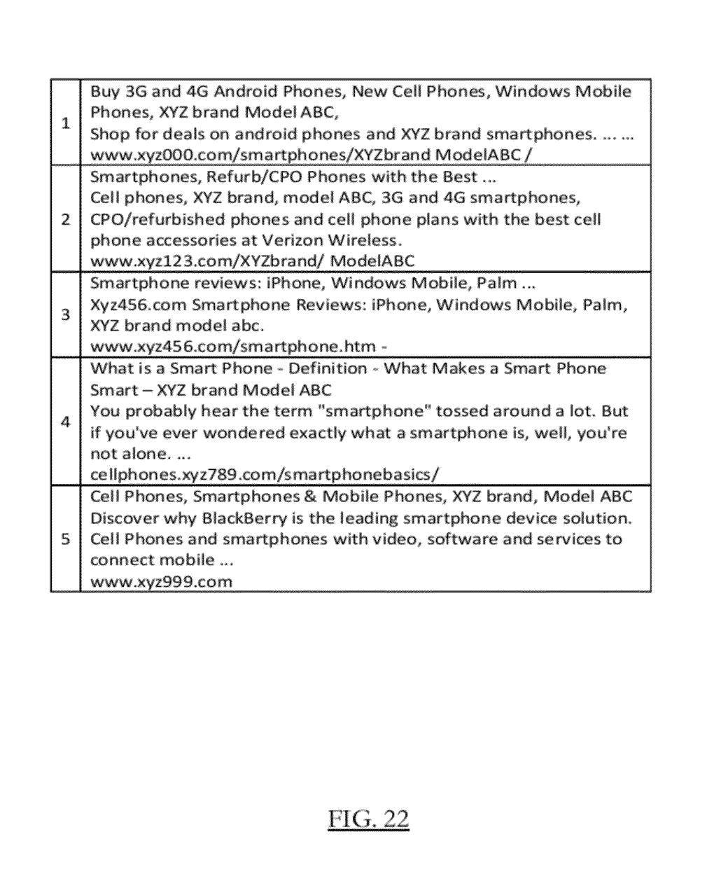

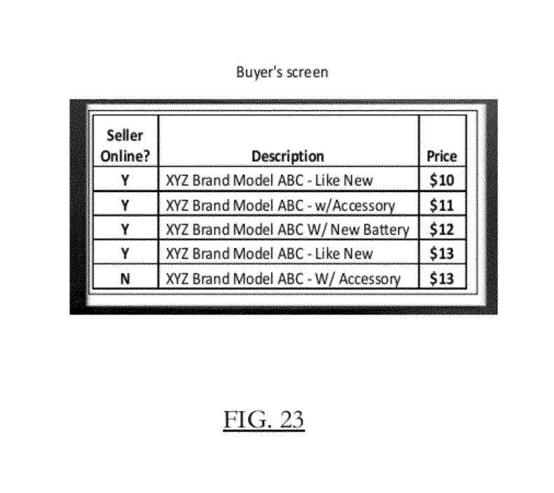

In step 409, contact lists, e.g., a list of contact information of the sellers (e.g., FIG. 23) or a list of contact information of the buyers (e.g., FIG. 24), may be stored as part of the phone contact information in a mobile phone and can be sorted by merchandise of interest by the mobile phone application software. In a possible embodiment, there are two possible scenarios 1) a seller receives a contact list of buyers, and 2) the buyer receives a contact list of sellers. In the first scenario, once a seller enters his merchandise information into the system, the server may automatically perform a search of the database for buyers that are interested in the merchandise or any aspects of the merchandise. Alternatively, the seller may enter search parameters that relate to his merchandise into the system in order to find buyers that are interested in merchandise related to his or her merchandise, the server may perform a search of the database for such buyers using the search parameters. The server can create a contact list of all of the buyers from the search. The information in the contact list may include any combination of: the buyer's name or nickname, the buyer's email address, the buyer's phone number, the buyer's rating/reputation/popularity, any comments that the buyer has made for merchandise related to the seller's merchandise, the buyer's IM address, the buyer's Twitter ID, the buyer's social networking site ID, icon/avatar/picture that the buyer uses, custom ring tone, etc. The server then sends the contact list to the seller's computing device.

In the second scenario, a buyer enters his or her search parameters into the system, the server may perform a search of the database for sellers that have merchandise matching the search parameters and/or have any merchandise that have any aspects matching the search parameters. The server can create a contact list of all of the sellers from the search. The information in the contact list may include any combination of: the seller's name or nickname, the seller's email address, the seller's phone number, the seller's rating/reputation/popularity, any comments that the seller has made about the merchandise, the seller's IM address, the seller's Twitter ID, the seller's social networking site ID, pictures of the merchandise, icon/avatar/picture that the seller uses, custom ring tone, etc. The merchandise and price of the merchandise may be stored as part of the contact information. The server then sends the contact list to the buyer's computing device.

The contact list of buyers or sellers may be received from the server by a device and automatically integrated (by an application program, plug-in, API, etc.) into any of: a phone book of a mobile phone, a contact list of an IM client, a contact list of a texting application program, an address book of an email application program, a contact list of a communication application program (e.g., SKYPE, Google Talk, Yahoo Messenger, Twitter, etc.), etc. The contacts may be sorted by merchandise, seller reputation/ranking/popularity, buyer reputation/ranking/popularity, price, etc. The sorting and display may be accomplished via any of: a standalone application program in the device receiving the contact list, a plug-in or API in the device, etc. A buyer or seller can activate the program or device feature that displays the contact list and can perform the desired sort of the contact list via the program or device feature. For example, in the first scenario discussed above, the seller finds a buyer in the contact list that he or she wants to sell the merchandise to. The seller simply selects the buyer's phone number, email address, IM ID, Twitter ID, social networking site ID, etc., from the contact list and contacts the buyer via the appropriate medium. For example, the seller is using a cell phone and selects the buyer's phone number from the contact list. The cell phone automatically dials the buyer's phone number. In another example, the seller is using a cell phone and selects the buyer's email address from the contact list. The program displaying the contact list instantiates the cell phone's email program and passes the buyer's email address to the email program with an indication that an email message is to be created with the buyer's email address as the recipient. The email program opens an email message to the buyer using the email address. In yet another example, the seller is using a cell phone and selects the buyer's IM ID from the contact list. The program displaying the contact list instantiates an appropriate IM program on the cell phone and passes the IM ID to the IM program. The IM program opens a dialog box to the buyer's IM ID.

For example, in the second scenario discussed above, the buyer can scroll through the seller contact list and look at the merchandise descriptions, information, and/or pricing. The buyer finds a seller in the contact list that he or she wants to buy the merchandise from or ask questions relating to the merchandise. The buyer simply selects the seller's phone number, email address, IM ID, Twitter ID, social networking site ID, etc., from the contact list and contacts the seller via the appropriate medium. For example, the buyer is using a cell phone and selects the seller's phone number from the contact list. The cell phone automatically dials the seller's phone number. In another example, the buyer is using a cell phone and selects the seller's email address from the contact list. The program displaying the contact list instantiates the cell phone's email program and passes the seller's email address to the email program with an indication that an email message is to be created with the seller's email address as the recipient. The email program opens an email message to the seller using the email address. In yet another example, the buyer is using a cell phone and selects the seller's IM ID from the contact list. The program displaying the contact list instantiates an appropriate IM program on the cell phone and passes the IM ID to the IM program. The IM program opens a dialog box to the seller's IM ID.

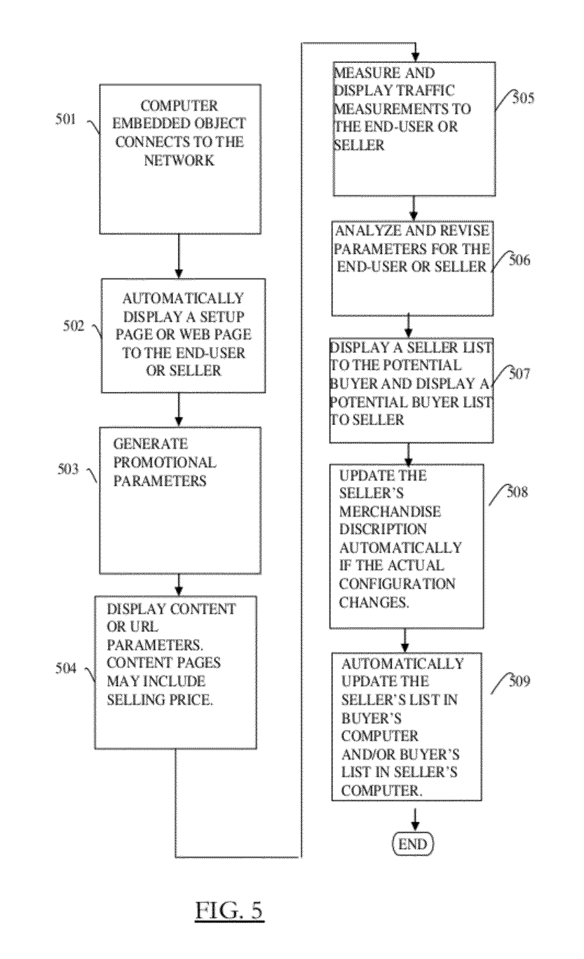

FIG. 5 is similar to FIG. 4, except in Step 503, promotional parameters that can be any parameters that improve the visibility or network traffic can be generated. This may be in addition to, or alternative to, keywords of the web pages, as shown in step 403. One of the promotional parameters may be a payment to a marketing campaign organizer that offers network traffic targets to a certain groups of potential customers. The marketing campaign can be pay-per-click, link exchange, network advertisement (banner or text based), etc. The payment may be by percentage of the final selling price of the merchandise, pay-per-click, by impression, etc.

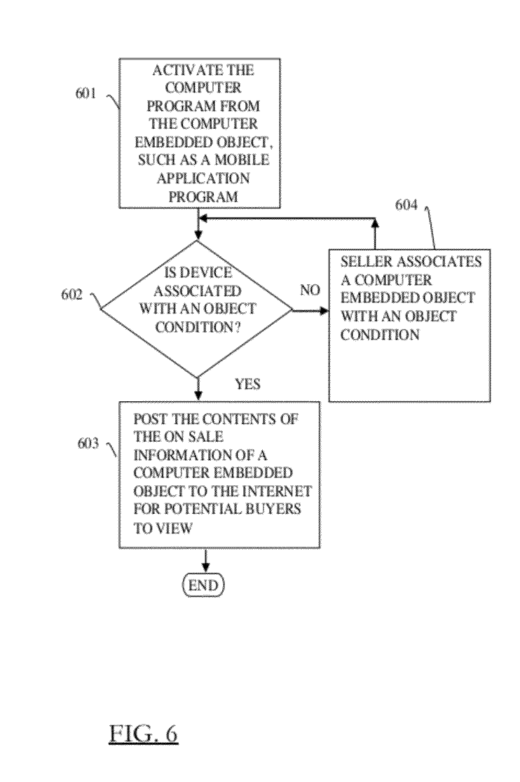

FIG. 6 illustrates a process flow of a possible embodiment. In a possible embodiment, Step 502 may be replaced by Steps 601, 602, 604. Once the computer embedded object is connected to the network 501, a software application may be launched 601. The application software can check if the physical condition of the computer embedded object has been entered by the seller or not 602. If yes, the system posts the merchandise, the computer embedded object, on sale information to the database 14 (step 603). The potential buyer may be able to search the database 14 and to view the merchandise, the computer embedded object, on sale information. In one possible embodiment, the merchandise on sale information may be displayed to a user that links to the seller on a social networking site, such as Google Plus, Facebook, LinkedIn, etc. If no, the system may ask the seller to enter the physical condition of the computer embedded object 604, e.g., via a user interface as shown in FIG. 17.

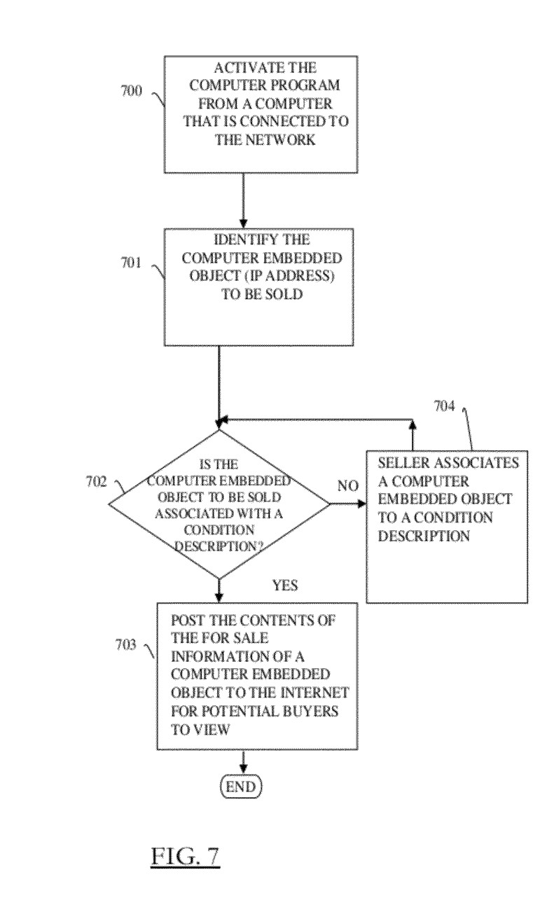

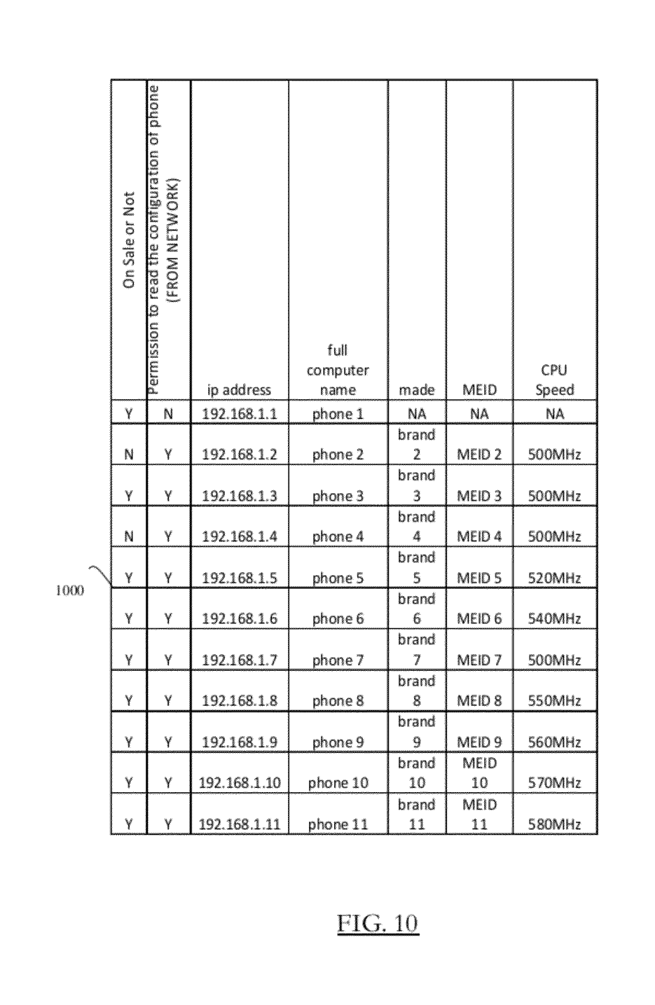

FIG. 7 illustrates a process flow of a possible embodiment. In step 700, a software application runs on a computer that is connected to a network and identifies and manages the merchandise. In step 701 the application software identifies which computer embedded object is for sale. FIG. 10 illustrates a possible user interface that may be displayed to the seller. In step 702, the application software may check the physical condition of each computer embedded object has been entered by seller or not. If yes, the system posts the merchandise, the computer embedded object, on sale information to the database 14 (step 703). The potential buyer may be able to search the database 14 and to view the merchandise, the computer embedded object, on sale information. In one possible embodiment, the merchandise on sale information may be displayed to a user that links to the seller on a social networking site, such as Google Plus, Facebook, LinkedIn, etc. Alternatively, steps 503-509 may be performed. If no, the system can ask the seller to enter the physical condition of the computer embedded object to add to the merchandise information (FIG. 17 illustrates an example user interface).

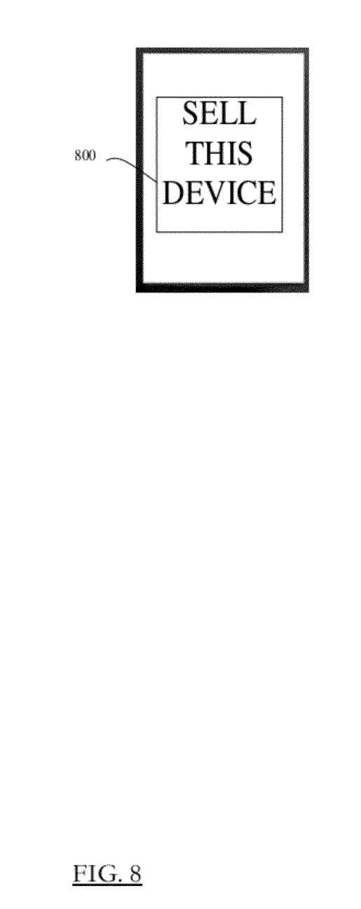

FIG. 8 illustrates a possible user interface for a seller. Once the application software is installed in the computer embedded object and is executed, the software begins by allowing the user to initiate the sale process by clicking or touching button 800 on the input device of the computer embedded object.

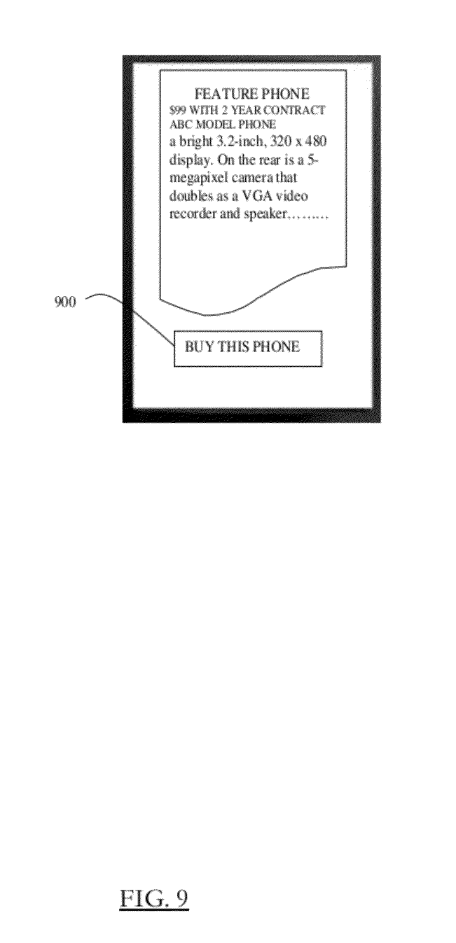

FIG. 9 illustrates a possible user interface for a potential buyer. The buyer can visit the seller's mobile website as shown in the FIG. 9. The features of the merchandise and the phone, in this example, purchase button can be presented to any potential buyer. Once the “BUY THIS PHONE” button 900 has been clicked or pushed and submitted to the server, a check out process begins.

FIG. 10 illustrates a possible user interface for the seller to manage selling a device that is connected to the network. A column in the table contains check boxes 1000 to indicate if the device on the network has been selected for sale or not. The device information may not be uploaded for the buyer to review if the phone is not for sale. FIG. 10 also shows IP addresses, computer names, manufacturer, MEID, CPU speed, and features of the devices that are connected to the Internet. Each of the devices can give permission to the seller that is connected to the network to access the phone configuration and specification. This permission may be given through the application software running on each of devices. In a possible embodiment, the network management software running on the seller's computer and the application software running on each of the computer embedded objects communicate in order for the seller to manage his merchandise through the network. The system may then proceed with the steps in FIG. 4, 5, or 6 in order to prepare information for a device that has been selected to be for sale. In a possible embodiment, the specification or identification code or configuration of the computer embedded object may be accessed by a user computer with the hostname or computer name of the merchandise computer embedded object, where a hostname or computer name is a label that is assigned to a computer embedded object (the merchandise) connected to a computer network and that is used to identify the computer embedded object in various forms of electronic communication. The user ID and/or password may be needed, along with the hostname or computer name of the computer embedded object, in order to gain access to the specification, identification code, or configuration of the merchandise computer embedded object. In a possible embodiment, the specification, identification code, or configuration of the computer embedded object may be stored in a flash memory, non-volatile memory, or disk drive (e.g., located in the computer embedded device, in communication with the computer embedded device, etc.). In a possible embodiment, the hostname or computer name of the computer embedded object is the hostname or computer name of the merchandise computer embedded object; instead of an IP address assigned to the merchandise computer embedded object. The identification code of the merchandise computer embedded object may be used, by the server or user computer, to search a database and to identify more specifications of the merchandise computer embedded object.

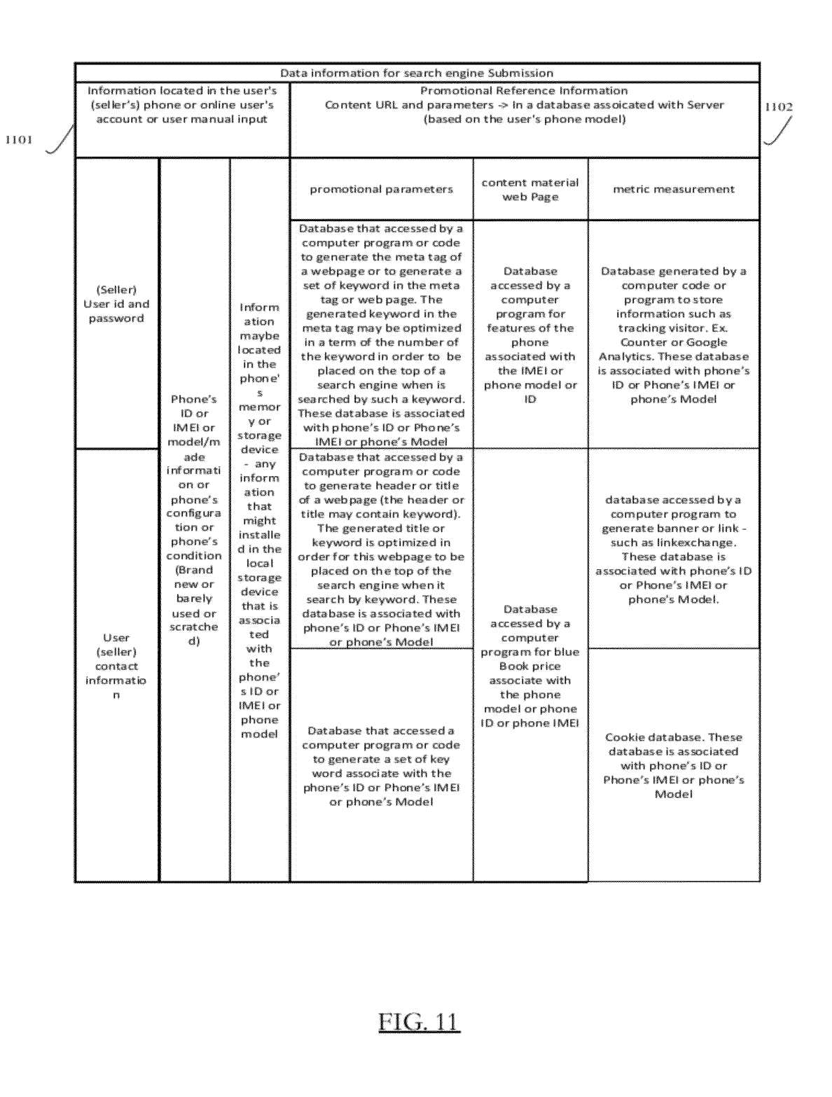

FIG. 11 illustrates a data structure related to a possible embodiment. A web page containing merchandise information is created and optimized automatically by the system or the seller with assistance from the system in order to obtain better search rankings in search engines in order to receive more network traffic. The reference information may be sorted or stored per ID of the computer embedded object in a database 14 or local database located in the memory device of the computer embedded object. Information may be stored in the storage device that is associated with the computer embedded object including any of: the seller's user id and password associated with the server account, the seller's contact information (e.g., email address, phone number, etc.), ID/specification/configuration of the computer embedded object, information related to the ID of the computer embedded object, etc. Database 14 may store promotional reference information which may include information related to: promotional parameters (e.g., a set of keywords related to the ID of the computer embedded object, a number of keywords for obtaining better search engine results, meta tag keywords, web page title, etc.), material to construct a web page (e.g., specification, feature, or price related to the ID of the computer embedded object, etc.), network traffic metric measurements (e.g., software or code that can be included in a web page to measure the network traffic, user id or password for viewing the network traffic statistics, software for fine tuning the web page in order to increase network traffic, software or code that can be inserted into a web page for a banner exchange program, cookies that can be installed in network visitors' computers to track visitors' activities—cookies that are installed in a visitor's computer can be linked to the ID of a computer embedded object in addition to the IP address), etc.

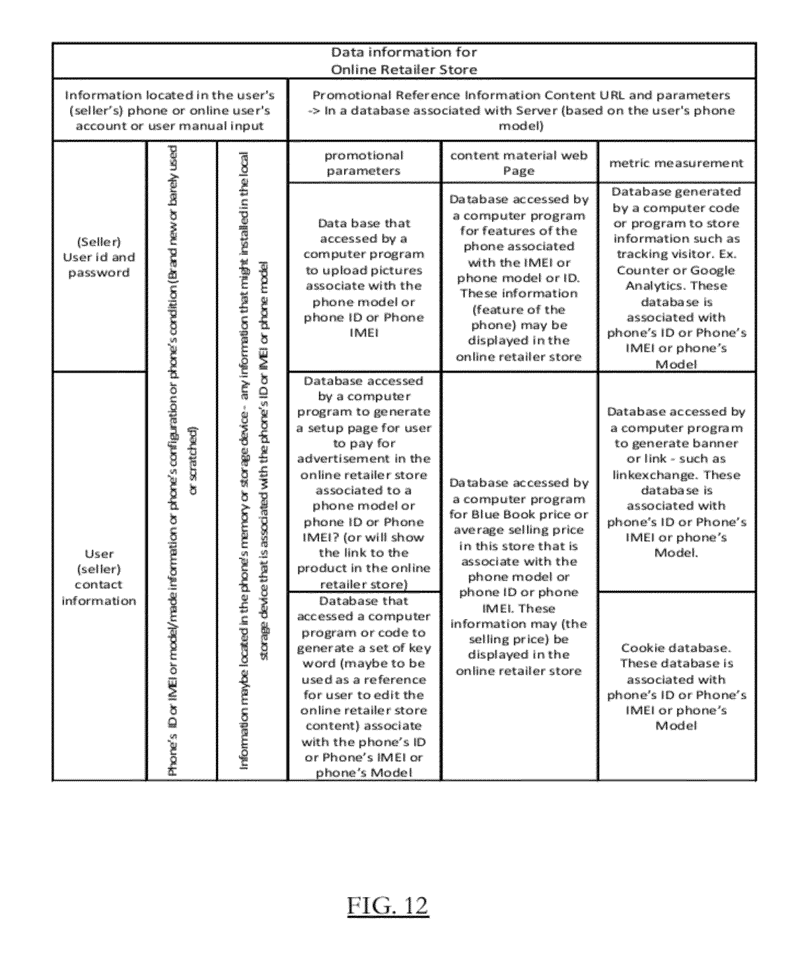

FIG. 12 illustrates a data structure related to a possible embodiment. An online retailer store's storefront or web page that contains merchandise information can be optimized by the system or seller with assistance from the system to position the seller's computer embedded object information on the online retailer store's storefront or web page in order to generate more network traffic for the seller. The reference information may be sorted or stored per ID of the computer embedded object in a database 14 or local database located in the memory device of the computer embedded object. Information may be stored in the storage device that is associated with the computer embedded object including any of: the seller's user id and password associated with the online retailer store, the seller's contact information (e.g., email address, phone number, etc.), ID/specification/configuration of the computer embedded object, information related to the ID of the computer embedded object, physical condition of the computer embedded object, etc. Database 14 may store promotional reference information which may include information related to: promotional parameters (e.g., picture(s) of the model of the computer embedded object, advertisement opportunity for merchandise offered by the online retailer store, etc.), material to construct a store front web page (e.g., specification, feature, price, or average selling price related to the ID of the computer embedded object, etc.), network traffic metric measurements (e.g., software or code that can be included in a web page to measure the network traffic, user id or password for viewing the network traffic statistics, software for fine tuning the web page in order to increase network traffic, software or code that can be inserted into a web page for a banner exchange program, cookies that can be installed in network visitors' computers to track visitors' activities—cookies that are installed in a visitor's computer can be linked to the ID of the computer embedded object in addition to the IP address), etc.

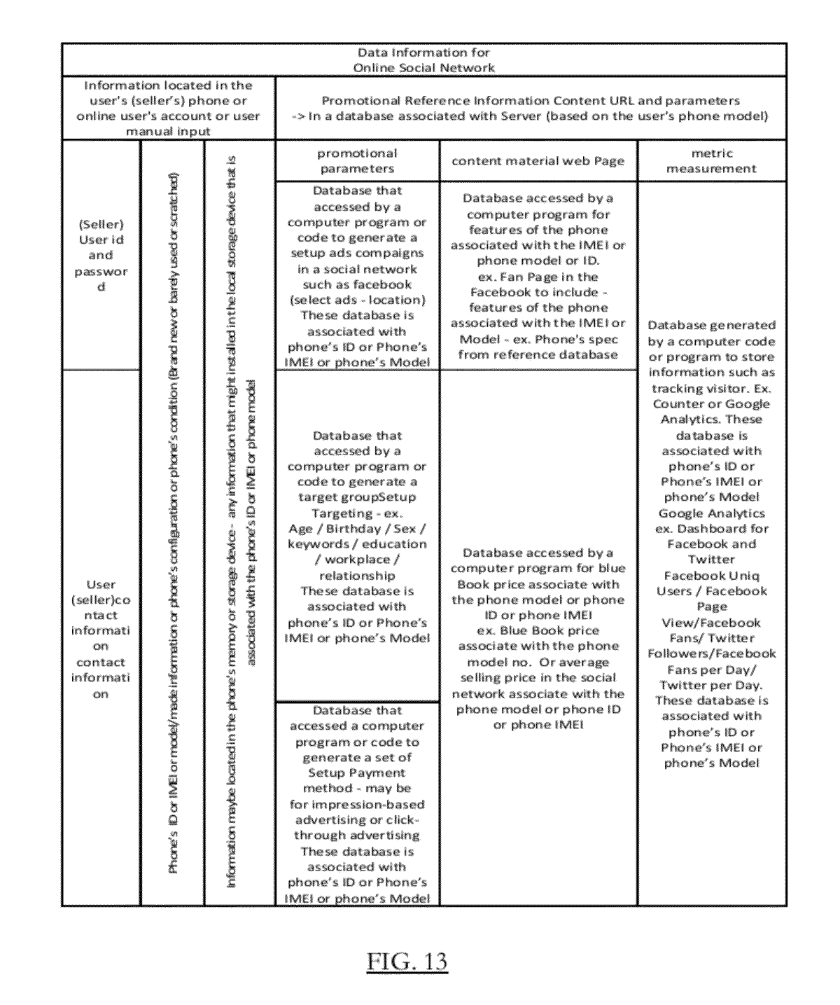

FIG. 13 illustrates a possible data structure related to a possible embodiment of the invention. An online social networking site or web page that contains merchandise information can be optimized by the system or seller with assistance from the system to position the seller's computer embedded object information on the online social networking site or web page in order to generate more network traffic for the seller. The reference information may be sorted or stored per ID of the computer embedded object in a database 14 or local database located in the memory device of the computer embedded object. Information may be stored in the memory device that is associated with the computer embedded object including any of: the seller's user id and password associated with the online social networking site, the seller's contact information (e.g., email address, phone number, etc.), ID/specification/configuration of the computer embedded object, information related to the ID of the computer embedded object, physical condition of the computer embedded object, etc. Database 14 may store promotional reference information which may include information related to: promotional parameters (e.g., picture(s) of the model of the computer embedded object, advertisement opportunity for merchandise offered by the online social networking site, potential buyer target group (e.g., education, sex, age, profession, etc.) with respect to the ID of the computer embedded object), material to construct an online social networking web page (e.g., specification, feature, price, or average selling price related to the ID of the computer embedded object, twitter page with title of the computer embedded object model, discussion group pages that talk about the model of the computer embedded object, etc.), network traffic metric measurements (e.g., software or code that can be included in a web page to measure the network traffic, user id or password for viewing the network traffic statistics, software for fine tuning the web page in order to increase network traffic, software or code that can be inserted into a web page for a banner exchange program, cookies that can be installed in network visitors' computers to track visitors' activities—cookies that are installed in a visitor's computer can be linked to the ID of the computer embedded object in addition to the IP address), etc.

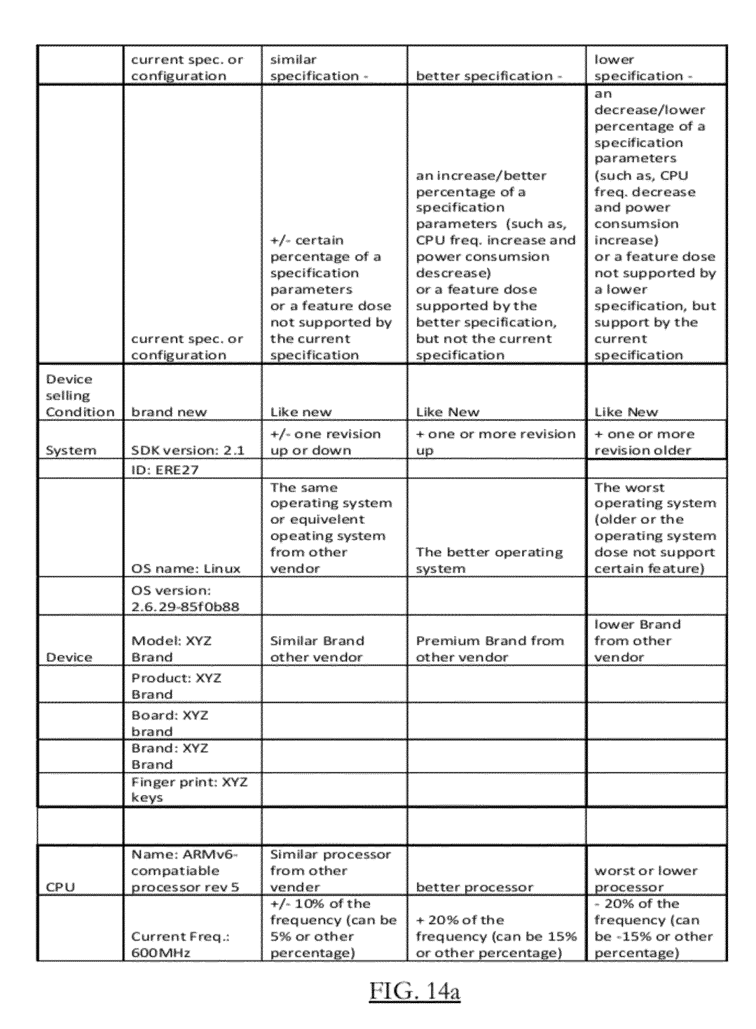

FIGS. 14a and 14b illustrate a possible comparison table that compares specification information of different computer embedded objects. Comparisons of specification information may include: a similar, lower, better, and current computer embedded object specifications.

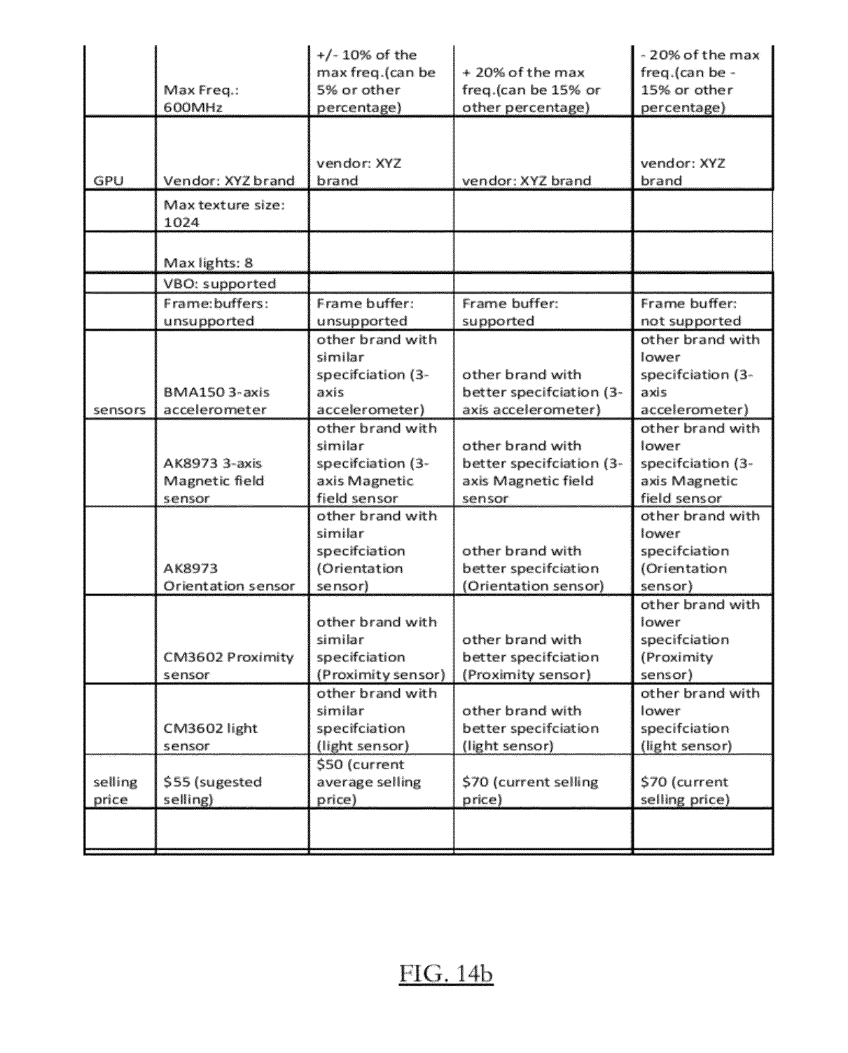

FIG. 15 illustrates a list of promotional parameters for various objects (e.g., phones, etc.) that maybe sold. These promotional parameters may be used to create web pages.

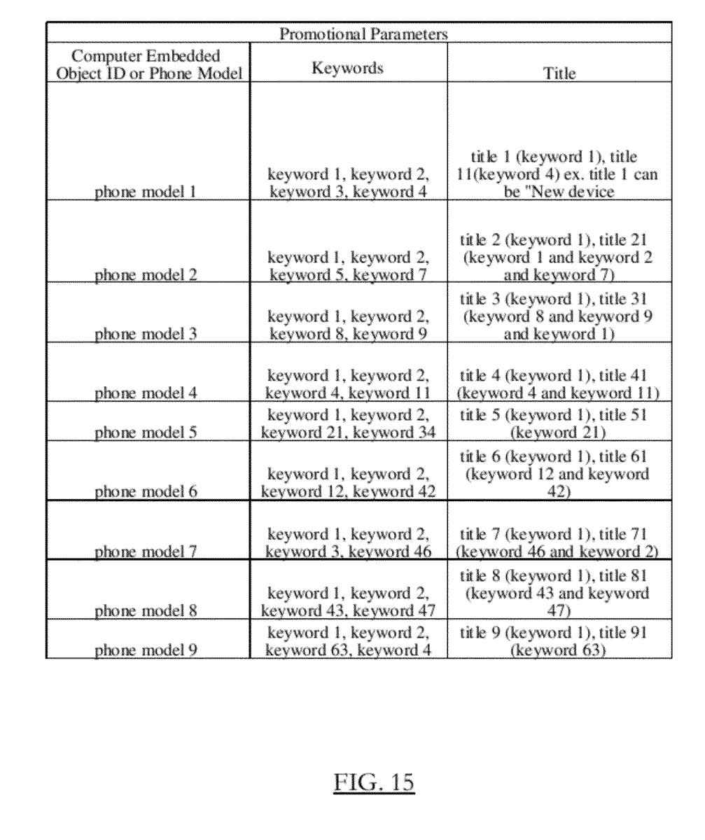

FIG. 16 illustrates an example of promotional parameters used to create a web page for promoting objects (e.g., phones, etc.);

FIG. 17 illustrates an example seller user input interface for a seller to add additional information that describes the object being sold. The additional information may relate to the condition of the current object for sale.

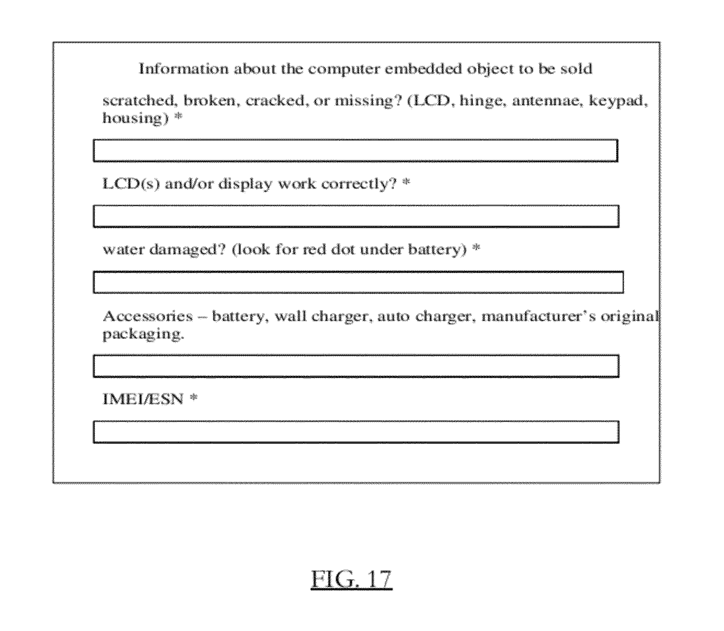

FIG. 18 illustrates an example seller user interface for recycling an object;

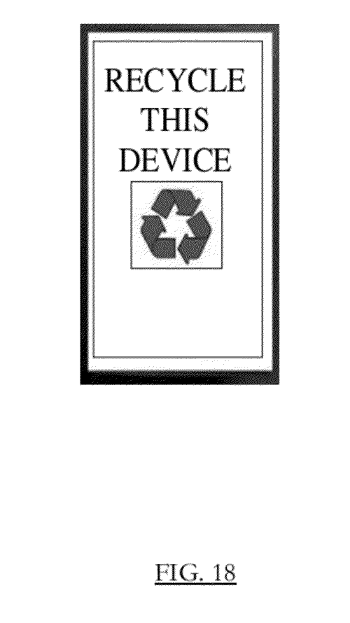

FIG. 19 illustrates a web page template before 1901 and after 1902 the seller's computer embedded object is identified. The upper area 1901 is the web page template. The lower area 1902 is the “HTML” content after the model of the computer embedded object is identified.

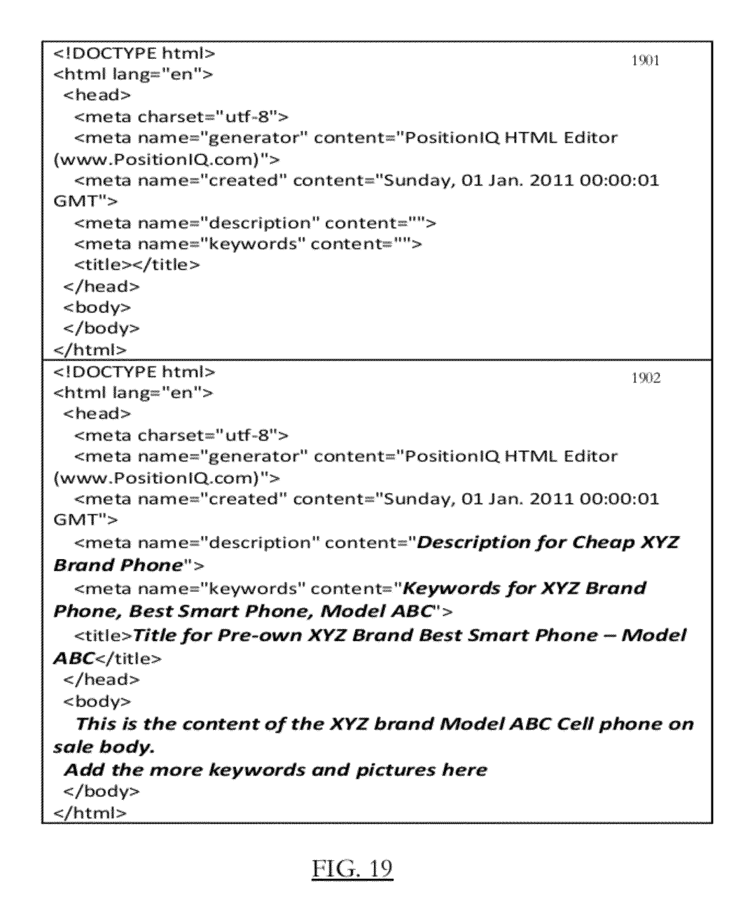

FIG. 20 illustrates a block diagram of a possible embodiment. Data can be stored in multiple data storage hardware. These might include a local hard disk 2012 in a seller's computer 2010, a memory device 2022 of the object being sold 2020, and a server's database 2014. Database 2014 can be accessed by seller's computer 2010 and the object being sold 2020.

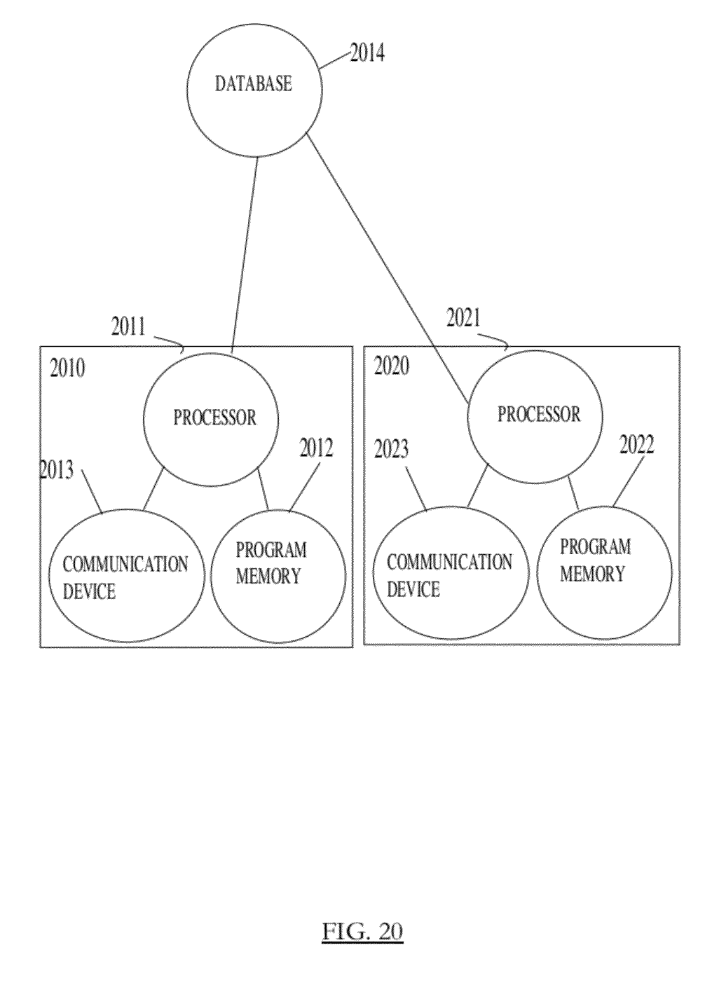

FIG. 21 illustrates another block diagram of a possible embodiment where data can be stored in multiple data storage hardware. These might include a database on a local hard disk 2113 or memory device 2114 in a seller's computer 2111, a database 2114, a database on a local hard disk 2123 or memory device 2122 in a buyer's computer 2120, and a database on a local hard disk 2133 or memory device 2130 on a server computer 2130. Database 2114 can be accessed by seller's computer processor 2111, buyer's computer processor 2121, and server's computer processor 2131.

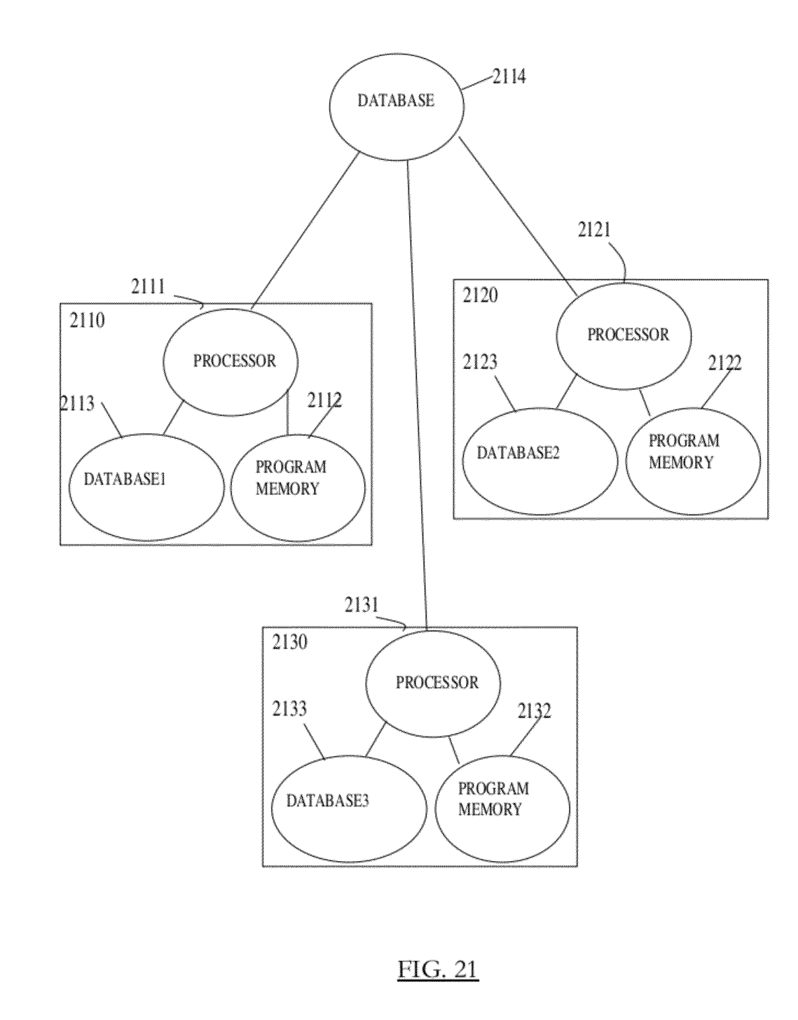

FIG. 22 illustrates a list of a seller's computer embedded object model or specification search results in a search engine. The computer embedded object may be a smart phone in this example. The ranking of the search results may be fine-tuned by the promotional parameters mentioned in FIG. 15, above. As a result of the fine-tuning, the traffic of the created web page is increased.

FIG. 23 illustrates a possible buyer's user interface listing computer embedded objects for sale, the price of each computer embedded object, and whether a particular seller is online. The listing could also include any of: each seller's rating, each seller's contact method, each seller's identification, etc.

FIG. 24 illustrates a possible seller's user interface listing potential buyers for a computer embedded object, whether a particular buyer is online, and the number of times the buyer has visited the computer embedded object description. The listing could also include any of: each buyer's rating, each buyer's contact method, each buyer's identification, etc.

In a possible embodiment, a “similar configuration” or a “similar specification” may be introduced. Once the computer ID or configuration of the computer embedded object has been uploaded to the server, the server can search according to the configuration attribute of the computer embedded object to find similar specifications of the computer embedded object. The database 14 can be categorized for computer embedded objects, e.g., sports cars with 3000 cc engines can be in one category. If the seller's computer embedded object is a Lexus sports car with a 3000 cc engine, the server may display this Lexus 3000 cc sports car to an owner of a Honda 3000 cc sport car in a social network. A similar configuration or similar specification may be defined, but is not limited to, as the same category of computer embedded objects stored in database 14.

A “sales condition” or a “contingency sale” can also be monitored. For example, if a potential buyer is looking for a replacement of an old computer embedded object, the transaction may only be finalized if the potential buyer of the computer embedded object is able to sell his old computer embedded object. This condition may be in place as part of the transaction condition. In another example, if a seller is looking for a replacement of his computer embedded object, the transaction may only be finalized if the seller of the computer embedded object is able to purchase a replacement for his computer embedded object within a certain time frame. This condition may be in place as part of the transaction condition.

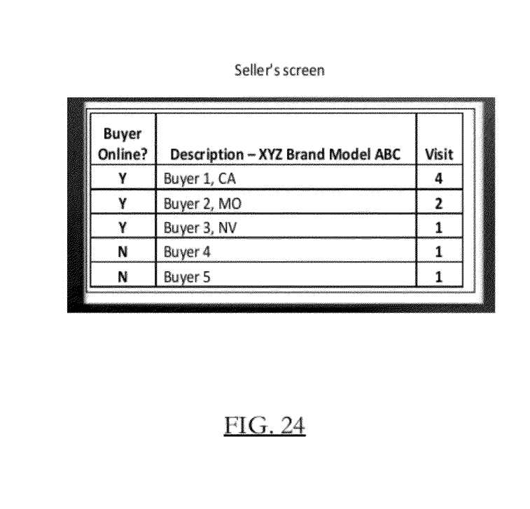

FIG. 25 illustrates a possible seller's user interface. The information in the user interface may be part of the phonebook of the seller's smart phone. The potential buyer's contact information and browsing history may be shown as part of the phonebook. The seller may be able to contact the buyer directly if the phone number of the buyer is available to the seller.

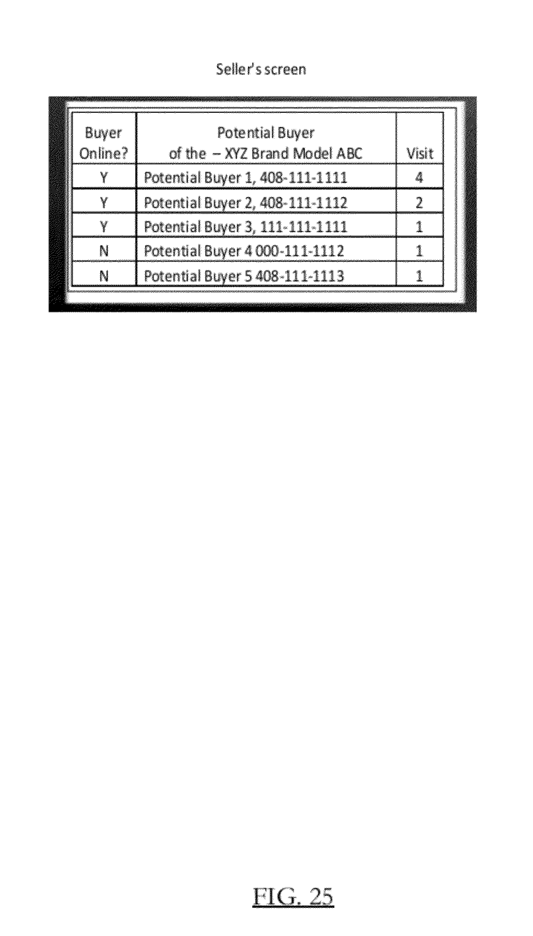

FIG. 26 illustrates a possible comment enabler to a database. The user might not be able to post comments about an XYZ brand smart phone, if the user is using an ABC brand smart phone. For example, an XYZ brand smart phone owner may be able to post his comments from a XYZ brand smart phone. Either the API from server or the application software from the local smart phone has the ability to identify the owner with a valid XYZ brand smart phone; if the owner has a valid phone, the comment will be posted. The verification process may be in terms of reading the ID of the user's computer embedded object, in this example it is the smart phone.

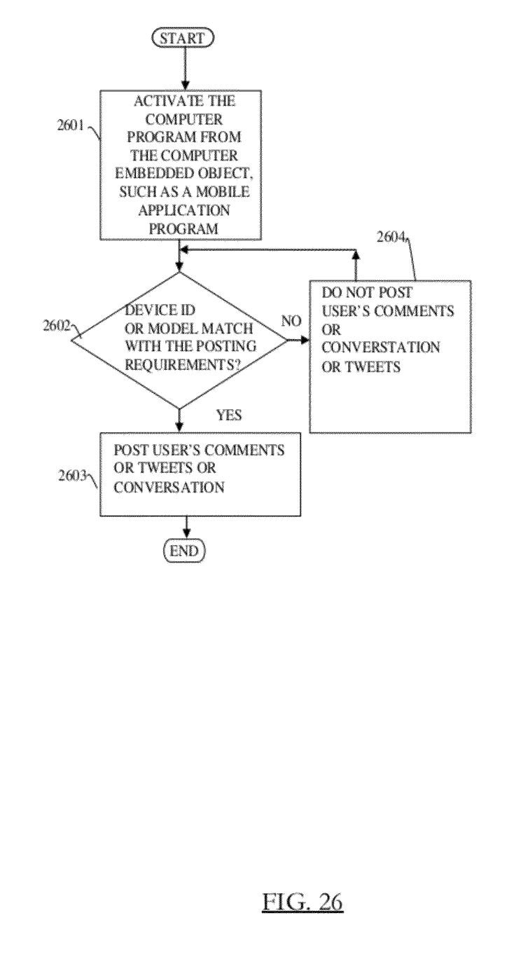

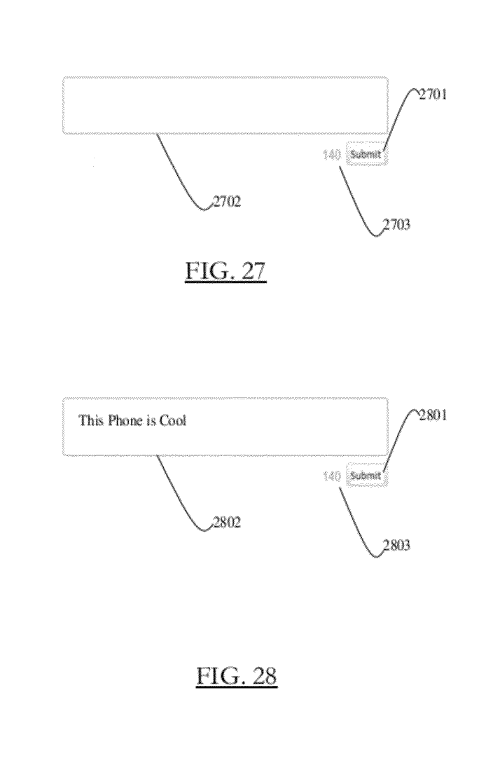

FIGS. 27 and 28 illustrate a possible user interface for a social networking site. Users may be able to enter comments into the comment box of the user interface.

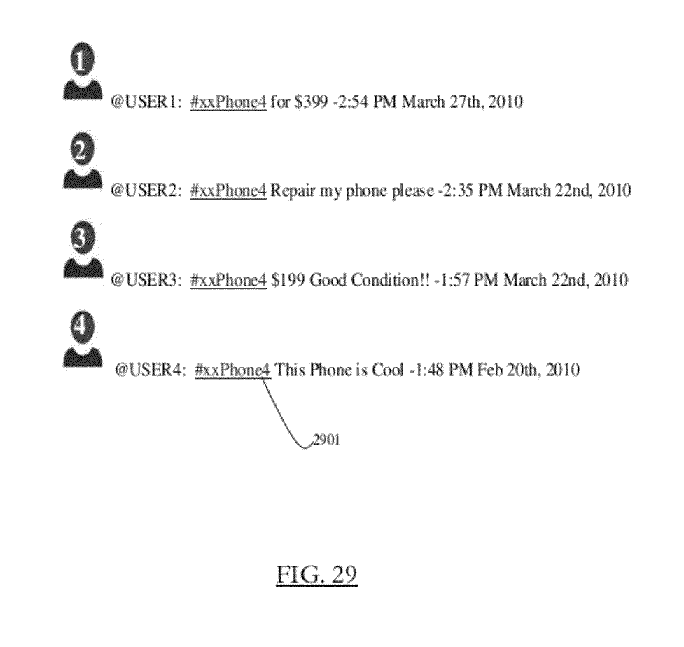

FIG. 29 illustrates a possible user interface for a social network. Users can view comments after a search. For example, this might be a search result from a social comments site where the search key word is xxPhone4. All of the comments containing #xxPhone4 may be shown in the search results. The user 4's comments might be a result of clicking Box 2801. The text “#xxPhone4” may be inserted by the server after reading the ID of the computer embedded object.

A possible embodiment may integrate this functionality into a social networking site, IDSNS (ID in Social Networking Sites). A seller may be able to login into IDSNS with a userid and password. The seller may leave comments, such as tweets or hashtags as in the Twitter sites, to the network database and for other users to “Follow”, such as the “Follow” function in the Twitter site. A portion or all of the comments that users leave on the network database may be derived from a user's ID, specification, or configuration of the computer embedded object. Where the ID may be from real time reads from the memory of the computer embedded object. Users may sort or track comments by an ID, specification, or configuration of a computer embedded object. One of the possible embodiments adds the ID of the computer embedded object after a user enters the comments in box 2702 of FIG. 27. In this possible embodiment, a special character, such as, but is not limited to, “#”, may be added and inserted as part of the comments in front of the user's ID of the computer embedded object (2901 of FIG. 29). A seller may enter “This phone is cool” in box 2802 of FIG. 28. The text “#xxPhone4 This phone is cool” may be displayed to all the users that view this set of comments (FIG. 29). The “#xxPhone4” may be inserted after a user clicks on box 2801 and the text “#xxPhone4 This phone is cool” can be viewed by all the users in the IDSN. The string “xxPhone4” is now a link to search results for all comments containing “#xxPhone4” in the message. In FIG. 29, “#xxPhone4” 2901 is the device stamp and “This Phone is Cool—1:48 PM Feb. 20, 2010” 2902 http://twitter.com/I_amLaw is the message with a time stamp. The string “xxPhone4” may be derived from an ID, IMEI, configuration, or specification of the computer embedded object that a user interacts with, which may require real time reads from the device's memory. The “Submit” button 2701 may be replaced by a “Tweet” button for the user to submit the comments to the server. In this case, the seller may be using the xxPhone 4 (the model of the cell phone) to uploaded his own comments and sell his xxPhone4. A price tag might be associated with the for sale merchandise. The device stamp, such as real time reading of the ID, configuration, or specification of the computer embedded object, is extracted at the time of processing a computer process, such as sending a message. The device stamp may consist of a string of code and may represent MadeModelYearOSRevision. In one case, the string may be “Orange-xxPhone3-2010-iOSc4.0”, where Orange is the company, make is xxPhone3, year (manufacture date) is 2010, and iOSc4.0 is the OS revision.

Where one of the social networking sites is Twitter, the seller may login into Twitter with a username and password (Handle). Tweets or hashtags may be derived from an ID, specification, or configuration of a computer embedded object. The seller may upload the model or price (or ID) of computer embedded object as part of the tweets or hashtags. In this example, the keyword that is generated from the ID of the computer embedded object of the seller may be a hashtag or part of a tweet (using Twitter's terminology). The seller may also craft tweets or hashtags that are derived from words and phrases relevant to people's phone ID, specification, or configuration of their computer embedded object. Information (ID, specification, configuration, or other information) of the computer embedded object of the follower may be uploaded as part of the retweets. The follower may manually input the information as part of the retweet. A version of the social network, maybe another version of Twitter, may only allow, automatically, a user (seller or buyer) to have a certain type of computer embedded object to “tweet” and/or “retweet” on some specific topics. The ID of a computer embedded object may be uploaded to the server after the “Tweet” button (box 2701 of FIG. 27) is clicked by a seller. A software program can be executed after the button is clicked (2601 in FIG. 26).

The software component might read the ID, configuration, or specification of the seller's or a user's computer embedded object and compare the information to the topics or content of the merchandise web page or tweets. Comments or conversation may be posted only if the ID or specification of the computer embedded object meets a posting requirement specified by the web page owner or administrator, in this example it may be a certain type of mobile phone (e.g., a “Sony” phone may only leave a comment on Sony's merchandise web pages or tweets and/or only a Sony mobile phone seller can follow Sony's merchandise web pages or tweets). Specific topics might be any of buying, selling, or commenting of a computer embedded object. The “certain type of the computer embedded object” may mean a computer embedded object with a similar specification (e.g., as described in FIG. 14). A relevant community may be formed through this implementation. A restriction level (governing which user can tweet or retweet) may be adjusted by the site operator, owner, or administrator or may be another version of the social network or enhanced version of Twitter. This may be implemented through Twitter's API (or Twitter's developer tool). One may track conversations with a hashtag, ID, or model of the computer embedded object. The hashtag for an iPhone 4 may be “#iphone4”, for example. The conversation tracked may only be displayed on an allowed ID or model of the computer embedded object. In a possible embodiment, one may be able to tweet on a topic of an “XYZ” model phone from an “XYZ” model phone and sell the “XYZ” model phone from an “XYZ” model phone.

A device information search may be a process to derive one or more of the following information about the computer embedded object: user operational manual, service manual, maintenance manual or procedure, schematics of the computer embedded object, blue book selling price, etc. This searched information may be a result of a keyword search for the device on the Internet, where the keyword can be derived from the ID of the computer embedded object.

A certification may be issued to the computer embedded object after one or more of the following verifications: IMEI or ID stolen check (if the computer embedded object is not found in a stolen or theft database), network check (if the computer embedded object can be connected to the network from server), microprocessor speed check (if the microprocessor is above a certain speed criteria), memory check (if memory size is above a certain memory size), etc. These verifications may act as a pre-owned certification. The pre-owned certification may be added to the reference information as part of the information to promote the sale or transaction of the computer embedded object.

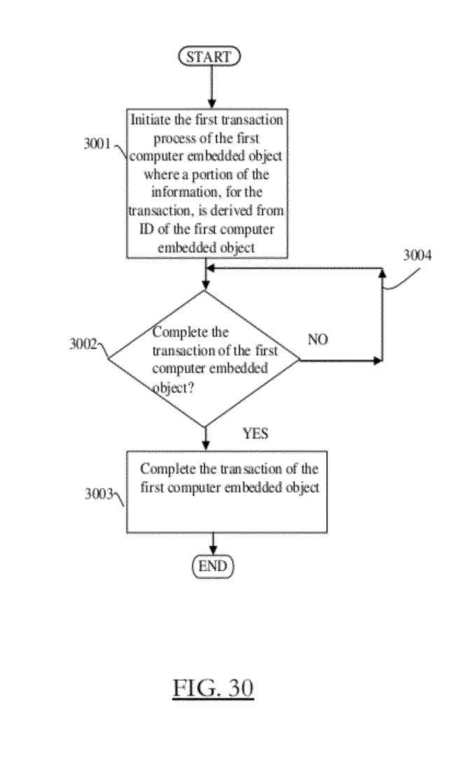

As illustrated in FIG. 30, in a possible embodiment, a seller may sell a computer embedded object with a contingency offer 3001. For example, the seller may keep the computer embedded object, such as a TV, on the market but accept a contingent offer, thereby providing a buyer with a 48-hour, or other time period, first-right-of-refusal notice to be performed in the event the seller receives a better offer. In this type of scenario, a seller may send a 48-hour notice to a buyer, informing the buyer that another offer has been received and the buyer then has 48 hours to remove the contingency by selling the buyer's existing TV 3002, 3004. If the buyer does not remove the contingency by selling his existing TV, the seller has the right to demand a cancellation of the contract and refund the earnest money deposit to the buyer. If the buyer removes the contingency by selling his existing TV, then the seller can sell the TV to the buyer 3003. The seller can keep the deposit if the buyer did not pay the full amount of the sale price within a period of time. When a contingency is removed, sellers may often ask for evidence of funds to close. In another example of contingency offers, the seller can take the item off the market and wait for the buyer to sell the buyer's existing computer embedded object, such as the buyer's existing TV. Most sellers may stipulate a date for the transaction to close. If the buyer's existing TV has not sold by that date, the transaction can be canceled. The completion of the first transaction of a first computer embedded object may depend on a portion of a process that is related to a second transaction of a second computer embedded object. The transaction may involve money, credit, exchange of goods, or any terms that can be agreed upon by both the seller and the buyer.

Upon the closing of a transaction, the seller can announce to the rest of the prospective buyers that the computer embedded object was sold. The seller may receive the shipping information related to the computer embedded object. The seller can upload all the private information associated with the computer embedded object to the network (e.g., cloud storage, server 10, etc.) for temporary storage. The seller can download the private information later once he receives a replacement computer embedded object. This allows the seller to preserve his settings and information between computer embedded objects.

### Example Embodiments and Applications

In a possible embodiment, a software component (a mobile application, e.g., Android or iPhone mobile applications, etc.) may be installed in a mobile phone (the computer embedded object in this example). The following is an example of possible embodiments and process flows. Note that any computer embedded object mentioned throughout the text may be used in the following examples.

As indicated in FIG. 6, Step 601, a software application has been installed in the mobile phone and has been activated.

In a possible embodiment, once the mobile application software (e.g., an online media site's mobile application, e.g., Amazon.com, etc.) is installed and the software is launched, the identification code or the configuration of the computer embedded object can be sent to the server automatically after the mobile application software has launched. The submission function to any of the online sites and the submission of identification code/configuration of the computer embedded object may not be available if it is a specific online retailer's mobile application that does not support the functionality.

Optionally, a setup page may be displayed to an end-user, once the mobile application is launched. The end-user can choose an online media site, e.g., Amazon.com, eBay, etc., to sell his or her computer embedded object. This may be skipped if the function is incorporated into the online media site's mobile application.

As in step 604, the seller can input the physical or functional condition of the mobile phone, e.g., using a user interface as illustrated in FIG. 17.

The identification code of the mobile phone may be uploaded to the server 10. As illustrated in FIG. 11, the information stored in the mobile phone can be uploaded to the database 14. Information to be transferred to the database 14 may include any of the following information: ID of the mobile phone, user id and password of the seller's account, specification of the seller's mobile phone, configuration of the mobile phone, etc.

The server 10 can search or access the database 14 based on the uploaded information. As a result, the promotional reference information 1102 can be retrieved by the server 10. The server may make the promotional reference information, related to the seller's mobile phone, available to the seller. The promotional reference information is catered to the seller's mobile phone as indicated in FIG. 11. The promotional reference information needed to obtain a better ranking from a search engine (FIG. 11), a better exposure on an online retailer store page (FIG. 12), and a social network on an online social network (FIG. 13) may be all stored in database 14. The promotional reference information may also be partially stored in the seller's mobile device and can be related to the information stored in database 14.

In a possible embodiment, the program running on the server and the mobile application software running on the seller's mobile phone can handshake and access the information stored in the mobile device and database 14 to facilitate the seller in constructing a media, such as a web page, to promote or sell the mobile device on the network/Internet. The promotional reference information may include any of: promotional parameters, content material for web pages, metric measurements to analyze the Internet traffic and generate corresponding keywords, landing pages or meta tags to improve the search ranking of certain keywords in search engines, etc. The promotional parameters used to improve the search engine rankings may include: keywords associated with the mobile phone model, keywords associated with the mobile phone ID, web page meta-tag keywords associated with the mobile phone, web page title(s) and/or web page header(s) associated with the mobile phone, etc. The total number of keywords in a web page and the location of the keywords may be monitored and adjusted by the mobile application software. The content material of the web page that are associated with the mobile phone's model or configuration may include the price of the mobile phone under various physical conditions of the mobile phone.

One of the possible ways to track and/or promote Internet traffic is the banner link exchange program that is associated with the ID of the seller's mobile phone. The banner associated with the ID or model number of the mobile phone can be generated for the seller to place it in a web page. The link exchange banners may be stored and sorted in database 14 by mobile phone model or ID of the mobile phone. The Internet traffic of the landing page, where the mobile phone on sale information is located, can be improved by fine tuning any of the: number of the keywords in the meta tag (web page), number of keywords in the web page, location of the keyword, amount of the money (or percentage of the selling price) paid to the marketing/on sale campaign (e.g., the banner exchange campaign, etc.), etc.

Promotional reference information may be reference information based on the seller's mobile phone ID or model number.

A software component can be installed in the buyer's mobile device. FIG. 23 indicates a possible user interface screen displayed on the buyer's mobile device by the software component. The buyer can shop for certain types of mobile phone devices given different sellers. The screen as illustrated in FIG. 23 shows whether the seller is online. The buyer can “text”, “call, “e-mail, or “chat” with the seller instantly. For example, a buyer may request, from the seller, more information related to the seller's merchandise. The seller may be able to send the requested information by, for example, email, to the buyer.

FIG. 24 illustrates a possible user interface screen on the seller's mobile device. The seller can view the Internet traffic sorted by buyers. For any repeat customers, the seller may be able to “text”, “call, “e-mail, or “chat” with the buyer instantly. Twitter (a social networking site) users may be able to send a “DM”, Direct Message, to each other. The message may be sent from a buyer, a follower, to the seller, the person that created the Tweet, or the seller to the buyer.

A two-way communication link can be established between the buyer and seller. The seller may be able to modify and fine tune the web page that promotes the mobile phone in order to get a better exposure or increase the network traffic. The seller can instantly monitor the buyers who are visiting/reviewing the mobile phone sales information. At the same time, the buyer can connect to the seller instantly and ask questions about the mobile phone much like in a brick and mortar store. Moreover, the buyer may be able to VPN directly to the mobile phone and review the internal configuration of the mobile phone.

In a possible embodiment, the system delivers information to a user, based on the specification or ID of the object that interacts with the user, where a portion of the information is derived from the specification or ID of the object that is not manually input by the user. The information can be related to one of the following information groups consisting of: the sale of merchandise or service information (including, but not limited to: the information or price information related to a sale of a vehicle or an auto part, information or selling price information related to a mobile device, information or selling price information related to an object equipped with a computer, information or selling price information related to a component or a tool to build an object equipped with a computer, etc.), on sale advertisement information (including, but not limited to: advertisement information or on sale information related to a vehicle or an auto part, advertisement information or on sale information related to a mobile device or an accessory of mobile device, advertisement information or on sale information related to an object equipped with a computer, information or on sale information related to a service for an object equipped with a computer (e.g., an auto repair service, etc.)), and on sale service information (including, but not limited to: service information, repair information, or service/repair labor cost information related to a vehicle, service information or wireless plan service related to a mobile device, service information, repair information, or service/repair labor cost information related to an object equipped with a computer).

The following are possible embodiments:

I. Plug and Sell->once a computer embedded object plugs into a sales network—or a trigger from end-user or seller of the computer embedded object connects it to the sales network:
i. The computer embedded object can automatically display a setup page that includes any of:
   1. Identification Code of the computer embedded object.
   2. Configuration of the computer embedded object:
      a. The ad database will be updated once the configuration is updated.
   3. Status of the computer embedded object if any:
      a. E.g., Mileage of a vehicle that the computer embedded object resides in.
   4. The product to be sold:
      a. The item to be sold may be an accessory instead of the computer embedded object itself.
   5. A submit button->send to the server.

II. Buyer and seller's network
i. Buyer and Seller network—both looking for items that can be specified by identification, configuration, or specification of a computer embedded object.
ii. Seller to upload the information to a seller website (or an online media, etc.).
iii. Buyer with a list of search key words to search the seller website (or an online media, etc.) to get the most relevant data out of the target information.
iv. The seller receives a list of potential buyers.
v. Seller and buyer establish a social network connection (both seller and buyer connected).

III. Plug and Social Networking, after the computer embedded object is connected to the network:
i. Setup page or template for seller to setup:
   1. Setup campaign (type or template of the campaign might be able to be generated after the ID Code or configuration of the computer embedded object has been loaded to the network).
   2. Content pages:
      a. Fan Pages:
         i. A page contains:
         1. ID and configuration of a product.
         2. A setup page that is for member of a social network to access the information of the product.
         ii. Provide fans with product listings and availability, product images, video, etc.
   3. Procure content—tools to generate the fan pages (The content template of the campaign can be loaded for an end-user or seller to review):
      a. Content for the following task:
         i. Marketing—involving ad creation, copywriting, design, planning, execution, campaign, community maintenance, etc.
      b. Linking the computer embedded object to a relevance site with information about the computer embedded object—which can be in forms of articles, essays, status updates, podcasts, videos, music, etc.
ii. Surveys, post discussions to facilitate dialogs, develop and nurture the relationship with the community influencers, collect feedback about the product, etc.
iii. Account setting:
   1. Seller account should have a status update button to update the status or configuration of the computer embedded object=>associate the status to the selling price.
   2. Reading the configuration and status of the computer embedded object—
      a. Such as the mileages
      b. Such as the where about the computer embedded object.
      c. Such as the memory option->how may Giga Byte of the SD card
      d. Real time reads the status of the vehicle—Engine Oil status
iv. Pages for customer to view news feed from the rest of the members in a seller's network once the Fan Page is online.
v. Track Metrics:
   1. Using tools such as the Omniture, Coremetrics, Webtrends, or Google Analytics:
      a. Recommend keywords and style of the content pages.

IV. Web page templates:
i. Meta tags.
ii. Content:
   1. Web content URL.
   2. Landing page URL.
   3. Keyword page URL.
iii. Price—from blue book, for example.
iv. Submit to search engine and receive traffic from search engine.

V. Google Adwords alike Internet site
i. Associated settings in an account:
   1. Preset->a list of the preset conditions assigned by the Internet site or set by the user. The user may be able trigger automatic reading of the ID, price, physical condition, or configuration of the computer embedded object.
   2. Seller account could have a status update button to update the status or configuration of the computer embedded object=>associate the status to the selling price.
   3. Reading the configuration and status of the computer embedded object may produce results such as:
      a. The mileage (for a vehicle).
      b. The geographic location of the computer embedded object.
      c. The memory options installed->e.g., how may Giga Bytes the SD card has.
      d. Real time reading of the status of the vehicle—e.g., engine oil level/temperature, etc.
ii. Generate the Ad Content:
   1. Kind of information generated for ads:
      a. head line and lines of merchandise description,
      b. unique selling propositions advertisement,
      c. distinguishing features and benefits advertisement,
      d. advertisements containing headlines,
      e. advertisements containing description lines,
      f. advertisements that include prices or discounts,
      g. advertisements focused on testimonials,
      h. advertisements that convey information,
      i. advertisement templates for seller to select among.
iii. Price
   1. Blue book price suggestion if it is a vehicle, etc.
iv. Key word
   1. Key word match method suggestions, such as:
      a. Match the price.
v. Links to the Google Site or the Ads Site, etc.
vi. Ads to be trigger or not triggered according to a set of conditions from the end user.

### Examples

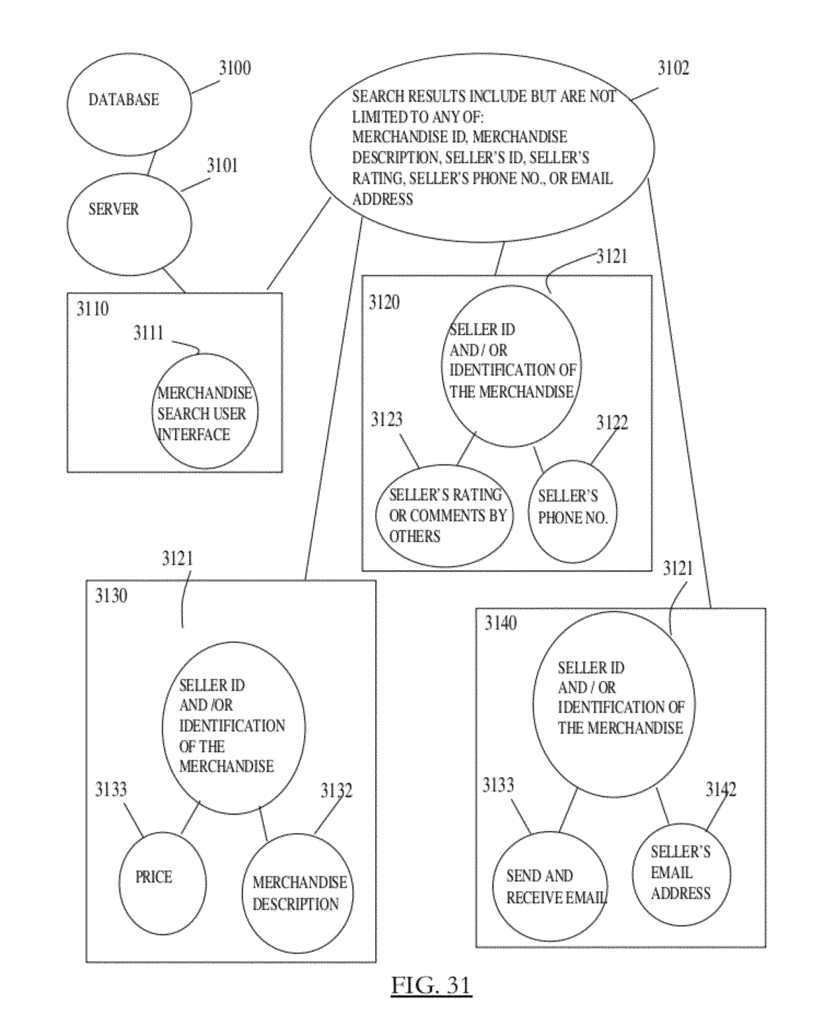

Referring to FIG. 31, database 3100 is a database that services user queries from server 3101. Application software 3110 sends queries to database 3100 via server 3101 using a merchandise search user interface 3111. Application software 3110 may reside on the user's computer embedded object, server 3101, or be accessible via another server.

The database search results 3102 are delivered by the merchandise search user interface 3111 to the user's computer embedded object. A typical search result 3102 may include, but is not limited to, any of: identification information of the merchandise offered for sale, the merchandise description, seller's identification information, seller's email address, or seller's phone number.

In a possible embodiment, application software 3120 may be a phone dialer resident on the user's computer embedded object, with the capability of displaying information from the search results to the user, such as any of: the seller's identification information and/or merchandise identification information 3121, seller's phone number 3122, or the seller's selling rating and other's comments on the seller 3123. The application software 3120 may be capable of placing or causing the initiation of a cell phone call, a voice over IP phone call, etc., via or using the user's computer-embedded object, using information from the search results and/or phone book resident on the user's computer embedded object. In a possible embodiment, the application software 3120 may, upon receipt of the search results, automatically save all or a portion of the search result information, such as the seller identification information and phone number(s) in a phone book on the user's computer embedded object for later retrieval by the application software 3120 or other application software. In a possible embodiment, the application software 3120 may, upon receipt of a user instruction, save all or a portion of the search result information, such as seller identification information and phone number(s) selected by the user in a phone book on the user's computer embedded object for later retrieval by the application software 3120 or other application software. The seller identification information may be displayed and sorted by application software 3120 along with any other contact identification existing on the user's computer embedded object (along with associated phone numbers). In a possible embodiment, a data field may be added by the application software 3120 to the phone book or display information to accommodate the identification of the merchandise offered for sale. The data field may include a link to the identification of a seller in the address book of the phone dialer. The data field may also store the identification information of the merchandise.

In a possible embodiment, application software 3120 may have any of: a phone dialer capability or a phone book capability or a phone dialer with internet web browser capability or a phone dialer with keyword search capability of the World Wide Web or phone dialer with keyword searching capability on the online shopping retailer site. In a possible embodiment, application software 3210 may include but not limit to the functionality of generating Dual Tone Muti-Frequency signal, to navigate a phone menus system, and the functionality of hypertext transfer protocol, for data communication with internet (World Wide Web). The application software 3120 may be installed on the user's computer embedded object such as a smart phone.

In a possible embodiment, application software 3140 may display seller identification information 3121 and seller email addresses 3142 from the search results. In a possible embodiment, the application software 3140 may be able to send and receive email messages 3133 using the information from the search results. In a possible embodiment, application software 3140 may, upon receipt of the search results, automatically save all or a portion of the search result information, such as seller email addresses on the user's computer embedded object for later retrieval. In a possible embodiment, application software 3140 may, upon receipt of a user instruction, save all or a portion of the search result information, such as seller email addresses on the user's computer embedded object for later retrieval. In a possible embodiment, 3140 may include but not limit to the functionality of Simple Mail Transfer Protocol, for sending and receiving email, and the functionality of hypertext transfer protocol, for data communication with internet (World Wide Web). The seller identification information 3121 may be displayed and sorted by application software 3140 along with any other contact identification existing on the user's computer embedded object (along with associated email addresses).

In a possible embodiment, application software 3140 may be an email client software with the capability of sending and receiving email. In a possible embodiment, application software 3140 may save seller contact information into another email client's contact information or its own. In a possible embodiment, application software 3140 may be able to send and receive email using the other email client or itself using contact information from the search results. In a possible embodiment, application software 3140 may have access to the other email client's address book. In a possible embodiment, a data field may be added by the application software 3140 to the address book or display information to accommodate the identification of the merchandise offered for sale. The data field may include a link to the identification of a seller in the address book of the email client. The data field may also store the identification information of the merchandise.

In a possible embodiment, application software 3130 may be able to display any of: the seller's identification information and/or merchandise identification information 3121, the merchandise description 3132, or price of the merchandise 3133. In a possible embodiment, application software 3130 may perform a transaction between a seller and buyer (user).

In a possible embodiment, application software 3130 may be a database software management tool that is capable of sorting and displaying a list of hardware items such as merchandise offered for sale along with any of: seller identification information and/or merchandise identification information 3121, merchandise description 3132, or sale price 3133.

In a possible embodiment, any combination of application software 3120, 3130, and 3140, maybe integrated. The integrated software may be installed in a computer embedded object such as smart phone. In a possible embodiment, an integrated software may have any combination of the following functionalities: email (send and receive email), address book (containing any of: seller identification information, seller email addresses and/or phone numbers, merchandise identification information, etc.), phone number dialer (with the ability to access an address book), shopping list (with the ability to sort/query merchandise offered for sale), or perform a sales transaction.

In an embodiment, a method comprises or a computer-readable medium carrying one or more sequences of instructions, which instructions, when executed by one or more processors, cause the one or more processors to carry out the steps of: receiving, by a server, at least one of an identification code or a specification of a computer embedded object for sale; automatically selecting, by the server, a plurality of parameters for populating a target web page relating to the at least one of the identification code or the specification of the computer embedded object; automatically creating, by the server, a web page that allows a user to select parameters from the plurality of parameters for populating a target web page; creating, by the server, at least a portion of the target web page using the selected parameters.

In an embodiment, a method or computer-readable medium further comprises wherein the identification code or specification is sent from the user's computer embedded object by a software application resident on the user's computer embedded object.

In an embodiment, a method or computer-readable medium further comprises wherein the server is any of the following: a server of a social networking site, a server of an online retailer site, a server of a online shopping search engine site, or a server of a RSS information feed site.

In an embodiment, a method or computer-readable medium further comprises automatically determining, by the server, similar computer embedded objects to the computer embedded object for sale; displaying, to users of the social networking site, information relating to the computer embedded object for sale where the users of the social networking site own similar computer embedded objects.

In an embodiment, a method or computer-readable medium further comprises automatically generating, by the server, promotional reference information relating to the at least one of the identification code or the specification of the computer embedded object.

In an embodiment, a method or computer-readable medium further comprises wherein the promotional reference information is retrieved from a database in communication with the server.

In an embodiment, a method or computer-readable medium further comprises wherein a total number of keywords in the target web page and/or the location of the keywords in the target web page are automatically monitored and adjusted by a mobile application software or the server to improve search rankings.

In an embodiment, a method or computer-readable medium further comprises sending the at least a portion of the target web page to a second user for display.

In an embodiment, a method or computer-readable medium further comprises wherein the at least one of the identification code or the specification is stored in a memory device of the computer embedded object.

In an embodiment, a method or computer-readable medium further comprises wherein the identification code is derived from a hostname of the computer embedded object and an identity authenticating password, and wherein a combination of the hostname of the computer embedded object and the identity authenticating password are used to access the identification code stored in the computer embedded object.

In an embodiment, a method or computer-readable medium further comprises receiving comment information relating to the computer embedded object from the user; sending the comment information to the second user for display.

In an embodiment, a method or computer-readable medium further comprises wherein the comment information comprises information about a usage experience of the user.

In an embodiment, a method or computer-readable medium further comprises wherein the comment information comprises a log file of the computer embedded object.

In an embodiment, a method or computer-readable medium further comprises wherein the comment information is a tweet.

In an embodiment, a method or computer-readable medium further comprises wherein the comment information is located in a fan page.

In an embodiment, a method or computer-readable medium further comprises wherein the identification code is delivered via a computer network.

In an embodiment, a method or computer-readable medium further comprises receiving a request for information related to the computer embedded object from the second user; and sending the request for information to the user for display.

In an embodiment, a method or computer-readable medium further comprises wherein the request for information comprises a question related to the computer embedded object.

In an embodiment, a method or computer-readable medium further comprises wherein request for information comprises a request for a log file of the computer embedded object.

In an embodiment, a method or computer-readable medium further comprises wherein the request for information is a tweet.

In an embodiment, a method or computer-readable medium further comprises wherein the request for information is located in a fan page.

In an embodiment, a method comprises or a computer-readable medium carrying one or more sequences of instructions, which instructions, when executed by one or more processors, cause the one or more processors to carry out the steps of: displaying to a user a list of a plurality of devices connected to a network; in response to a user indicating on the list that a device is for sale, uploading an identification code or a specification from the device; retrieving information relating to the identification code or the specification of the device; displaying the information to the user.

In an embodiment, a method or computer-readable medium further comprises automatically populating a target web page using information selected by the user from the displayed information.

In an embodiment, a method comprises or a computer-readable medium carrying one or more sequences of instructions, which instructions, when executed by one or more processors, cause the one or more processors to carry out the steps of: receiving, by a server, search terms from a plurality of potential buyers of merchandise; sending a list of potential buyers among the plurality of potential buyers to a seller, the list of potential buyers lists potential buyers with search terms relating to parameters of a product of the seller.

In an embodiment, a method or computer-readable medium further comprises wherein the list of potential buyers is stored in a contact list associated with a communication software component in a device associated with the seller.

In an embodiment, a method comprises or a computer-readable medium carrying one or more sequences of instructions, which instructions, when executed by one or more processors, cause the one or more processors to carry out the steps of: sending, by a user computer, search criteria to a server, the search criteria including search terms for objects that a user is interested in; receiving, by the user computer, search results from the server, the search results including merchandise of interest information, the merchandise of interest information including a contact list of one or more potential buyers; displaying, at the user computer, the received merchandise information and contact list in a contact section of a communication software installed on the user computer.

In an embodiment, a method or computer-readable medium further comprises wherein the contact section of the communication software is any of: a phone book of a mobile phone, an address book of an email application program, a contact list of a communication application program, or a contact list of a text messaging application program.

In an embodiment, a method comprises or a computer-readable medium carrying one or more sequences of instructions, which instructions, when executed by one or more processors, cause the one or more processors to carry out the steps of: sending, by a user computer, search criteria to a server, the search criteria including search terms for objects that a user is interested in; receiving, by the user computer, search results from the server, the search results including merchandise of interest information, the merchandise of interest information including a contact list of one or more sellers of the merchandise of interest; displaying, at the user computer, the received merchandise information and contact list in a contact section of a communication software installed on the user computer.

In an embodiment, a method or computer-readable medium further comprises wherein the contact section of the communication software is any of: a phone book of a mobile phone, an address book of an email application program, a contact list of a communication application program, or a contact list of a text messaging application program.

In an embodiment, a method comprises or a computer-readable medium carrying one or more sequences of instructions, which instructions, when executed by one or more processors, cause the one or more processors to carry out the steps of: displaying a web page to a plurality of users; receiving an identification code, configuration, or specification from a user's computer embedded object that is communicating with the web page; allowing a user with a computer embedded object having a specific identification code, configuration, or specification, to post comments or participate in conversations on the web page, the specific identification code or specification specified an owner or administrator of the web page.

In an embodiment, a method or computer-readable medium further comprises wherein the identification code, configuration, or specification is sent from the user's computer embedded object by a software application resident on the user's computer embedded object.

In an embodiment, a method comprises or a computer-readable medium carrying one or more sequences of instructions, which instructions, when executed by one or more processors, cause the one or more processors to carry out the steps of: receiving search results, the search results comprising any of: identification information of at least one merchandise offered for sale, description of the at least one merchandise offered for sale, identification information of at least one seller of the at least one merchandise offered for sale, email address of the at least one seller, or phone number of the at least one seller; automatically saving at least a portion of the search results in a phone book; displaying information in the phone book including the at least a portion of the search results.

In an embodiment, a method or computer-readable medium further comprises causing a phone call to be initiated using information from the at least a portion of the search results in the phone book.

In an embodiment, a method or computer-readable medium further comprises sending a search request to a server using identification information resident on a computer embedded object.

In an embodiment, a method comprises or a computer-readable medium carrying one or more sequences of instructions, which instructions, when executed by one or more processors, cause the one or more processors to carry out the steps of: receiving search results, the search results comprising any of: identification information of at least one merchandise offered for sale, description of the at least one merchandise offered for sale, identification information of at least one seller of the at least one merchandise offered for sale, email address of the at least one seller, or phone number of the at least one seller; automatically saving at least a portion of the search results in a contact list; displaying information in the contact list including the at least a portion of the search results.

In an embodiment, a method or computer-readable medium further comprises causing an email message to be sent using information from the at least a portion of the search results.

In an embodiment, a method or computer-readable medium further comprises sending a search request to a server using identification information resident on a computer embedded object.

In an embodiment, an apparatus comprises subsystems, implemented at least partially in hardware for: receiving, by a server, at least one of an identification code or a specification of a computer embedded object for sale; automatically selecting, by the server, a plurality of parameters for populating a target web page relating to the at least one of the identification code or the specification of the computer embedded object; automatically creating, by the server, a web page that allows a user to select parameters from the plurality of parameters for populating a target web page; creating, by the server, at least a portion of the target web page using the selected parameters.

In an embodiment, an apparatus further comprises wherein the identification code or specification is sent from the user's computer embedded object by a software application resident on the user's computer embedded object.

In an embodiment, an apparatus further comprises wherein the server is any of the following: a server of a social networking site, a server of an online retailer site, a server of a online shopping search engine site, or a server of a RSS information feed site.

In an embodiment, an apparatus further comprises automatically determining, by the server, similar computer embedded objects to the computer embedded object for sale; displaying, to users of the social networking site, information relating to the computer embedded object for sale where the users of the social networking site own similar computer embedded objects.

In an embodiment, an apparatus further comprises automatically generating, by the server, promotional reference information relating to the at least one of the identification code or the specification of the computer embedded object.

In an embodiment, an apparatus further comprises wherein the promotional reference information is retrieved from a database in communication with the server.

In an embodiment, an apparatus further comprises wherein a total number of keywords in the target web page and/or the location of the keywords in the target web page are automatically monitored and adjusted by a mobile application software or the server to improve search rankings.

In an embodiment, an apparatus further comprises sending the at least a portion of the target web page to a second user for display.

In an embodiment, an apparatus further comprises wherein the at least one of the identification code or the specification is stored in a memory device of the computer embedded object.

In an embodiment, an apparatus further comprises wherein the identification code is derived from a hostname of the computer embedded object and an identity authenticating password, and wherein a combination of the hostname of the computer embedded object and the identity authenticating password are used to access the identification code stored in the computer embedded object.

In an embodiment, an apparatus further comprises receiving comment information relating to the computer embedded object from the user; sending the comment information to the second user for display.

In an embodiment, an apparatus further comprises wherein the comment information comprises information about a usage experience of the user.

In an embodiment, an apparatus further comprises wherein the comment information comprises a log file of the computer embedded object.

In an embodiment, an apparatus further comprises wherein the comment information is a tweet.

In an embodiment, an apparatus further comprises wherein the comment information is located in a fan page.

In an embodiment, an apparatus further comprises wherein the identification code is delivered via a computer network.

In an embodiment, an apparatus further comprises receiving a request for information related to the computer embedded object from the second user; and sending the request for information to the user for display.

In an embodiment, an apparatus further comprises wherein the request for information comprises a question related to the computer embedded object.

In an embodiment, an apparatus further comprises wherein request for information comprises a request for a log file of the computer embedded object.

In an embodiment, an apparatus further comprises wherein the request for information is a tweet.

In an embodiment, an apparatus further comprises wherein the request for information is located in a fan page.

In an embodiment, an apparatus comprises subsystems, implemented at least partially in hardware for: displaying to a user a list of a plurality of devices connected to a network; in response to a user indicating on the list that a device is for sale, uploading an identification code or a specification from the device; retrieving information relating to the identification code or the specification of the device; displaying the information to the user.

In an embodiment, an apparatus further comprises automatically populating a target web page using information selected by the user from the displayed information.

In an embodiment, an apparatus comprises subsystems, implemented at least partially in hardware for: receiving, by a server, search terms from a plurality of potential buyers of merchandise; sending a list of potential buyers among the plurality of potential buyers to a seller, the list of potential buyers lists potential buyers with search terms relating to parameters of a product of the seller.

In an embodiment, an apparatus further comprises wherein the list of potential buyers is stored in a contact list associated with a communication software component in a device associated with the seller.

In an embodiment, an apparatus comprises subsystems, implemented at least partially in hardware for: sending, by a user computer, search criteria to a server, the search criteria including search terms for objects that a user is interested in; receiving, by the user computer, search results from the server, the search results including merchandise of interest information, the merchandise of interest information including a contact list of one or more potential buyers; displaying, at the user computer, the received merchandise information and contact list in a contact section of a communication software installed on the user computer.

In an embodiment, an apparatus further comprises wherein the contact section of the communication software is any of: a phone book of a mobile phone, an address book of an email application program, a contact list of a communication application program, or a contact list of a text messaging application program.

In an embodiment, an apparatus comprises subsystems, implemented at least partially in hardware for: sending, by a user computer, search criteria to a server, the search criteria including search terms for objects that a user is interested in; receiving, by the user computer, search results from the server, the search results including merchandise of interest information, the merchandise of interest information including a contact list of one or more sellers of the merchandise of interest; displaying, at the user computer, the received merchandise information and contact list in a contact section of a communication software installed on the user computer.

In an embodiment, an apparatus further comprises wherein the contact section of the communication software is any of: a phone book of a mobile phone, an address book of an email application program, a contact list of a communication application program, or a contact list of a text messaging application program.

In an embodiment, an apparatus comprises subsystems, implemented at least partially in hardware for: displaying a web page to a plurality of users; receiving an identification code, configuration, or specification from a user's computer embedded object that is communicating with the web page; allowing a user with a computer embedded object having a specific identification code, configuration, or specification, to post comments or participate in conversations on the web page, the specific identification code or specification specified an owner or administrator of the web page.

In an embodiment, an apparatus further comprises wherein the identification code, configuration, or specification is sent from the user's computer embedded object by a software application resident on the user's computer embedded object.

In an embodiment, an apparatus comprises subsystems, implemented at least partially in hardware for: receiving search results, the search results comprising any of: identification information of at least one merchandise offered for sale, description of the at least one merchandise offered for sale, identification information of at least one seller of the at least one merchandise offered for sale, email address of the at least one seller, or phone number of the at least one seller; automatically saving at least a portion of the search results in a phone book; displaying information in the phone book including the at least a portion of the search results.

In an embodiment, an apparatus further comprises causing a phone call to be initiated using information from the at least a portion of the search results in the phone book.

In an embodiment, an apparatus further comprises sending a search request to a server using identification information resident on a computer embedded object.

In an embodiment, an apparatus comprises subsystems, implemented at least partially in hardware for: receiving search results, the search results comprising any of: identification information of at least one merchandise offered for sale, description of the at least one merchandise offered for sale, identification information of at least one seller of the at least one merchandise offered for sale, email address of the at least one seller, or phone number of the at least one seller; automatically saving at least a portion of the search results in a contact list; displaying information in the contact list including the at least a portion of the search results.

In an embodiment, an apparatus further comprises causing an email message to be sent using information from the at least a portion of the search results.

In an embodiment, an apparatus further comprises sending a search request to a server using identification information resident on a computer embedded object.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

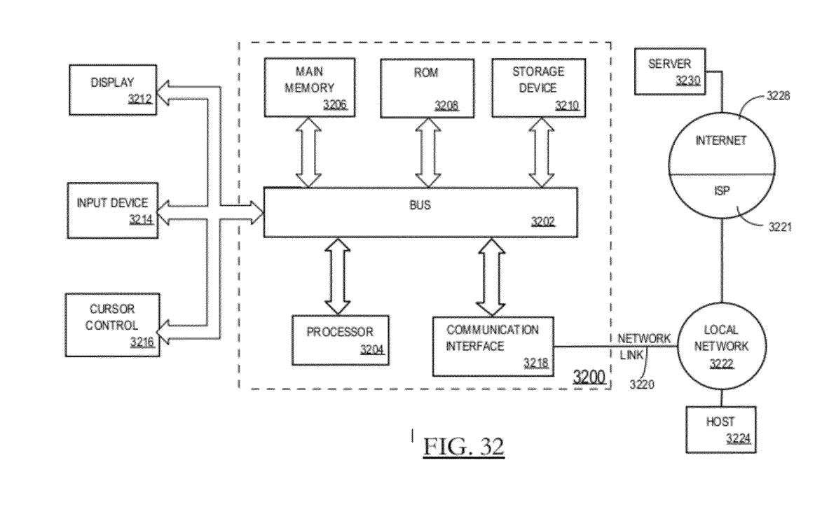

For example, FIG. 32 is a block diagram that illustrates a computer system 3200 upon which an embodiment of the invention may be implemented. Computer system 3200 includes a bus 3202 or other communication mechanism for communicating information, and a hardware processor 3204 coupled with bus 3202 for processing information. Hardware processor 3204 may be, for example, a general purpose microprocessor.

Computer system 3200 also includes a main memory 3206, such as a random access memory (RAM) or other dynamic storage device, coupled to bus 3202 for storing information and instructions to be executed by processor 3204. Main memory 3206 also may be used for storing temporary variables or other intermediate information during execution of instructions to be executed by processor 3204. Such instructions, when stored in non-transitory storage media accessible to processor 3204, render computer system 3200 into a special-purpose machine that is customized to perform the operations specified in the instructions.

Computer system 3200 further includes a read only memory (ROM) 3208 or other static storage device coupled to bus 3202 for storing static information and instructions for processor 3204. A storage device 3210, such as a magnetic disk or optical disk, is provided and coupled to bus 3202 for storing information and instructions.

Computer system 3200 may be coupled via bus 3202 to a display 3212, such as a cathode ray tube (CRT), for displaying information to a computer user. An input device 3214, including alphanumeric and other keys, is coupled to bus 3202 for communicating information and command selections to processor 3204. Another type of user input device is cursor control 3216, such as a mouse, a trackball, or cursor direction keys for communicating direction information and command selections to processor 3204 and for controlling cursor movement on display 3212. This input device typically has two degrees of freedom in two axes, a first axis (e.g., x) and a second axis (e.g., y), that allows the device to specify positions in a plane.

Computer system 3200 may implement the techniques described herein using customized hard-wired logic, one or more ASICs or FPGAs, firmware and/or program logic which in combination with the computer system causes or programs computer system 3200 to be a special-purpose machine. According to one embodiment, the techniques herein are performed by computer system 3200 in response to processor 3204 executing one or more sequences of one or more instructions contained in main memory 3206. Such instructions may be read into main memory 3206 from another storage medium, such as storage device 3210. Execution of the sequences of instructions contained in main memory 3206 causes processor 3204 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 3210. Volatile media includes dynamic memory, such as main memory 3206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 3202. Transmission media can also take the form of acoustic or light waves, such as those generated during radio-wave and infra-red data communications.

Various forms of media may be involved in carrying one or more sequences of one or more instructions to processor 3204 for execution. For example, the instructions may initially be carried on a magnetic disk or solid state drive of a remote computer. The remote computer can load the instructions into its dynamic memory and send the instructions over a telephone line using a modem. A modem local to computer system 3200 can receive the data on the telephone line and use an infra-red transmitter to convert the data to an infra-red signal. An infra-red detector can receive the data carried in the infra-red signal and appropriate circuitry can place the data on bus 3202. Bus 3202 carries the data to main memory 3206, from which processor 3204 retrieves and executes the instructions. The instructions received by main memory 3206 may optionally be stored on storage device 3210 either before or after execution by processor 3204.

Computer system 3200 also includes a communication interface 3218 coupled to bus 3202. Communication interface 3218 provides a two-way data communication coupling to a network link 3220 that is connected to a local network 3222. For example, communication interface 3218 may be an integrated services digital network (ISDN) card, cable modem, satellite modem, or a modem to provide a data communication connection to a corresponding type of telephone line. As another example, communication interface 3218 may be a local area network (LAN) card to provide a data communication connection to a compatible LAN. Wireless links may also be implemented. In any such implementation, communication interface 3218 sends and receives electrical, electromagnetic or optical signals that carry digital data streams representing various types of information.

Network link 3220 typically provides data communication through one or more networks to other data devices. For example, network link 3220 may provide a connection through local network 3222 to a host computer 3224 or to data equipment operated by an Internet Service Provider (ISP) 3226. ISP 3226 in turn provides data communication services through the world wide packet data communication network now commonly referred to as the “Internet” 3228. Local network 3222 and Internet 3228 both use electrical, electromagnetic or optical signals that carry digital data streams. The signals through the various networks and the signals on network link 3220 and through communication interface 3218, which carry the digital data to and from computer system 3200, are example forms of transmission media.

Computer system 3200 can send messages and receive data, including program code, through the network(s), network link 3220 and communication interface 3218. In the Internet example, a server 3230 might transmit a requested code for an application program through Internet 3228, ISP 3226, local network 3222 and communication interface 3218.

The received code may be executed by processor 3204 as it is received, and/or stored in storage device 3210, or other non-volatile storage for later execution.

### EQUIVALENTS, EXTENSIONS, ALTERNATIVES AND MISCELLANEOUS

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method, comprising:
receiving, by a server, at least one of an identification code or a specification of a computer embedded object for sale;
automatically selecting, by the server, a plurality of parameters for populating a target web page relating to the at least one of the identification code or the specification of the computer embedded object;
automatically creating, by the server, a web page that allows a user to select parameters from the plurality of parameters for populating a target web page;
creating, by the server, at least a portion of the target web page using the selected parameters.

2. The method of claim 1, wherein the identification code or specification is sent from the user's computer embedded object by a software application resident on the user's computer embedded object.

3. The method of claim 1, wherein the server is any of the following: a server of a social networking site, a server of an online retailer site, a server of a online shopping search engine site, or a server of a RSS information feed site.

4. The method of claim 1, further comprising:
automatically determining, by the server, similar computer embedded objects to the computer embedded object for sale;
displaying, to users of the social networking site, information relating to the computer embedded object for sale where the users of the social networking site own similar computer embedded objects.

5. The method of claim 1, further comprising:
automatically generating, by the server, promotional reference information relating to the at least one of the identification code or the specification of the computer embedded object.

6. The method of claim 5, wherein the promotional reference information is retrieved from a database in communication with the server.

7. The method of claim 1, wherein a total number of keywords in the target web page and/or the location of the keywords in the target web page are automatically monitored and adjusted by a mobile application software or the server to improve search rankings.

8. The method of claim 1, further comprising:
sending the at least a portion of the target web page to a second user for display.

9. The method of claim 1, wherein the at least one of the identification code or the specification is stored in a memory device of the computer embedded object.

10. The method of claim 1, wherein the identification code is derived from a hostname of the computer embedded object and an identity authenticating password, and wherein a combination of the hostname of the computer embedded object and the identity authenticating password are used to access the identification code stored in the computer embedded object.

11. The method of claim 8 further comprising:
receiving comment information relating to the computer embedded object from the user;
sending the comment information to the second user for display.

12. The method of claim 11, wherein the comment information comprises information about a usage experience of the user.

13. The method of claim 11, wherein the comment information comprises a log file of the computer embedded object.

14. The method of claim 11, wherein the comment information is a tweet.

15. The method of claim 11, wherein the comment information is located in a fan page.

16. The method of claim 1, wherein the identification code is delivered via a computer network.

17. A method of claim 8 further comprising:
receiving a request for information related to the computer embedded object from the second user; and
sending the request for information to the user for display.

18. The method of claim 17, wherein the request for information comprises a question related to the computer embedded object.

19. The method of claim 17, wherein request for information comprises a request for a log file of the computer embedded object.

20. The method of claim 17, wherein the request for information is a tweet.

21. The method of claim 17, wherein the request for information is located in a fan page.

22. A non-transitory computer readable medium storing a sequence of instructions, which when executed by one or more processors, cause performing steps of:
receiving, at a server, at least one of an identification code or a specification of a computer embedded object for sale;
automatically selecting, at the server, a plurality of parameters for populating a target web page relating to the at least one of the identification code or the specification of the computer embedded object;
automatically creating, at the server, a web page that allows a user to select parameters from the plurality of parameters for populating a target web page;
creating, at the server, at least a portion of the target web page using the selected parameters.

23. An apparatus, comprising:
a device, at a server, that receives at least one of an identification code or a specification of a computer embedded object for sale;
a device, at a server, that automatically selects a plurality of parameters for populating a target web page relating to the at least one of the identification code or the specification of the computer embedded object;
a device, at a server, that automatically creates a web page that allows a user to select parameters from the plurality of parameters for populating a target web page;
a device, at a server, that creates at least a portion of the target web page using the selected parameters.
